(19) United States
(12) Patent Application Publication
(10) Pub. No.: US 2024/0278423 A1
(43) Pub. Date: Aug. 22, 2024

(54) Robotic Dexterity With Intrinsic Sensing And Reinforcement Learning

(71) Applicant: The Trustees of Columbia University in the City of New York, New York, NY (US)

(72) Inventors: Matei Ciocarlie, New York, NY (US); Gagan Khandate, New York, NY (US); Maximilian Haas-Heger, New York, NY (US)

(21) Appl. No.: 18/613,576

(22) Filed: Mar. 22, 2024

Related U.S. Application Data
(63) Continuation of application No. PCT/US2022/044618, filed on Sep. 23, 2022.
(60) Provisional application No. 63/247,719, filed on Sep. 23, 2021.

(51) Int. Cl. B25J 9/16; B25J 15/00

(52) U.S. Cl. CPC B25J 9/163; B25J 9/1612; B25J 9/1671; B25J 15/0009

(57) ABSTRACT

A system for generating a model-free reinforcement learning policy for a robotic hand for grasping an object is provided, including a processor; a memory; and a simulator implemented via the processor and the memory, performing: sampling a plurality of stable grasps relevant to reorienting the grasped object about a desired axis of rotation and using stable grasps as initial states for collecting training trajectories; learning finger-gaiting and finger-grasping policies for each axis of rotation in the hand coordinate frame based on proprioceptive sensing in the robotic hand, wherein the finger-gaiting and finger-pivoting policy is implemented on the robotic hand.

### CROSS-REFERENCE TO RELATED APPLICATIONS

This application is a continuation of International Application PCT/US2022/044618, entitled “ROBOTIC DEXTERITY WITH INTRINSIC SENSING AND REINFORCEMENT”, filed Sep. 23, 2022, which claims priority to and the benefit of U.S. Provisional Application, Ser. No. 63/247,719, entitled “ROBOTIC DEXTERITY WITH INTRINSIC SENSING AND REINFORCEMENT”, filed Sep. 23, 2021, the entirety of which is incorporated by reference in its entirety herein.

### GOVERNMENT RIGHTS STATEMENT

This invention was made with government support under N00014-21-1-4010, and N00014-19-1-2062 awarded by the Office of Naval Research, and 1551631, and 1734557 awarded by the National Science Foundation. The government has certain rights in the invention.

### BACKGROUND

Dexterous in-hand manipulation is the ability to move a grasped object from one pose to another desired pose. Humans routinely use in-hand manipulation in performing many tasks such as re-orienting a tool from its initial grasped pose to a useful pose, securing a better grasp on the object, exploring the shape of an unknown object and other such complex tasks. This makes robotic in-hand manipulation an important step towards the general goal of manipulating objects in cluttered and unstructured environments such as a kitchen or a warehouse where such tasks are abundant. Despite significant advances in manipulation mechanics, hand design, and sensing, the problem of controlling dexterous hands for versatile in-hand manipulation remains a long-standing unsolved challenge.

### SUMMARY

Although reinforcement learning (RL) has been successful in demonstrating diverse in-hand manipulation skills both in simulation and on real hands, the policies are object-centric and require large training times. More importantly, these policies have not been demonstrated with arbitrary orientations of the hand, as it is expected that the palm supports the object during manipulation—a consequence of the policies being trained with the hand in palm-up orientation to simplify training. The policies also require extensive external sensing involving multi-camera systems to track the fingers and/or the object, systems that are hard to deploy outside the lab environments.

With regards to sensing, tactile feedback has a strong potential in enabling versatile in-hand manipulation skills that resist perturbation forces, adapt to variations in object and contact properties and other unmodelled differences such as transmission dynamics, inertia, backlash that corrupts proprioceptive feedback, and the like. However, integrating tactile feedback with RL is a challenge on its own. Besides the general difficulty of simulating the transduction involved, tactile feedback is often high dimensional which can prohibitively drive up the number of training samples required. Hence, prior works using RL for in-hand manipulation either entirely avoid using tactile feedback or consider tasks requiring fewer training samples where it is feasible to learn directly with the real hand.

The disclosure escribed herein focuses on achieving arbitrary in-hand object re-orientation by combining in-grasp manipulation and finger-gaiting. In-grasp manipulation is a specific type of in-hand manipulation skill where the fingertips re-orient the grasped object while maintaining contacts. The kinematic constraints of the hand while maintaining contacts restrict the range of re-orientation this skill can achieve on its own. Finger-gaiting, another in-hand manipulation skill, involves breaking and making contact to substitute one finger for another without dropping the object. It is an invaluable skill because it can overcome the kinematic constraints of in-grasp manipulation and achieve potentially limitless object re-orientation.

In one aspect, we combine in-grasp manipulation and finger-gaiting in-hand manipulation skills for large in-hand re-orientation. Finger-gaiting involves making and breaking contact to achieve re-grasping and finger substitutions without dropping the object which makes it an invaluable skill for large in-hand re-orientation: it does not face the kinematic constraints of in-grasp manipulation and thus in combination with in-grasp manipulation we can achieve potentially limitless object re-orientation.

In another aspect, RL is also used to enable in-hand manipulation skills but with a few significant differences. First and foremost, we train our policies to perform in-hand manipulation only using force-closed precision fingertip grasps (e.g. precision in-hand manipulation without requiring the presence of the palm underneath the object for support), and thus enable our policies to be used in arbitrary orientations of the hand. However, the task of learning to manipulate only via such precision grasps is a significantly harder problem: action randomization, responsible for exploration in reinforcement learning, often fails as the hand almost always drops the object. As a solution, we propose designing appropriate initial state distributions, initializing episode rollouts with a wide range of grasps as an alternative exploration mechanism. To this end, we train our policies to achieve continuous object re-orientation about a specified axis. First, we find this formulation to have significantly better sample efficiency for learning finger-gaiting. But more importantly, it does not require knowledge of absolute object pose, which in turn would require cumbersome external sensing. With this approach, we learn policies to rotate object about cardinal axes and combine them for arbitrary in-hand object re-orientation.

Critically, we learn our policies with low dimensional contact location and force feedback, on the way towards future transfer of the policies on our hand with tactile sensors that accurately predict contact location & force and are also easy to simulate (including noise). We also leave out the object pose feedback achieving in-hand manipulation purely using internal on-board sensing. We show that these policies are robust i.e. they resist perturbations and cope up with noise in feedback and object agnostic i.e., they generalize to unseen objects, all the while requiring significantly fewer samples to train.

According one aspect, a system for generating a model-free reinforcement learning policy for a robotic hand for grasping an object is provided, including a processor; a memory; and a simulator implemented via the processor and the memory, performing: sampling a plurality of stable grasps relevant to reorienting the grasped object about a desired axis of rotation and using stable grasps as initial states for collecting training trajectories; learning finger-gaiting and finger-grasping policies for each axis of rotation in the hand coordinate frame based on proprioceptive sensing in the robotic hand, wherein the finger-gaiting and finger-pivoting policy is implemented on the robotic hand.

In some embodiments, the sampling of a plurality of varied stable grasps comprises initializing the grasped object in a random pose and sampling a plurality of fingertip positions of the robotic hand. In some embodiments, the sampling is based on a number of fingertip contacts on the grasped object.

In some embodiments, the finger-gaiting and finger-grasping policies for each axis of rotation are combined.

In some embodiments, the proprioceptive sensing provides current positions and controller set-point positions of the robotic hand. In some embodiments, the robotic hand is a fully-actuated and position-controlled robotic hand.

In some embodiments, a reward function associated with a critic of the simulator is based on the angular velocity of a grasped object along a desired axis of rotation. In some embodiments, a reward function associated with a critic of the simulator is based on the number of fingertip contacts on a grasped object and the separation between a desired and a current axis of rotation.

According to one aspect, a method for generating a model-free reinforcement learning policy for a robotic hand for grasping an object includes sampling a plurality of stable grasps relevant to reorienting the grasped object about a desired axis of rotation and using stable grasps as initial states for collecting training trajectories; learning finger-gaiting and finger-grasping policies for each axis of rotation in the hand coordinate frame based on proprioceptive sensing in the robotic hand, and implementing the finger-gaiting and finger-pivoting policy on the robotic hand.

In some embodiments, the sampling of a plurality of varied stable grasps comprises initializing the grasped object in a random pose and sampling a plurality of fingertip positions of the robotic hand. In some embodiments, the sampling is based on a number of fingertip contacts on the grasped object.

In some embodiments, the finger-gaiting and finger-grasping policies for each axis of rotation are combined.

In some embodiments, the proprioceptive sensing provides current positions and controller set-point positions of the robotic hand.

In some embodiments, the method includes providing a reward function associated with a critic of the simulator is based on the angular velocity of a grasped object along a desired axis of rotation. In some embodiments, the method includes providing a reward function associated with a critic of the simulator is based on the number of fingertip contacts on a grasped object and the separation between a desired and a current axis of rotation.

According to one aspect, a robotic hand implementing a model-free reinforcement learning policy for a robotic hand for grasping an object includes a processor; a memory storing finger-gaiting and finger-grasping policies built on a simulator by: a simulator implemented via the processor and the memory, sampling a plurality of stable grasps relevant to reorienting the grasped object about a desired axis of rotation and using stable grasps as initial states for collecting training trajectories; learning finger-gaiting and finger-grasping policies for each axis of rotation in the hand coordinate frame based on proprioceptive sensing in the robotic hand, and a controller implementing the finger-gaiting and finger-pivoting on the robotic hand.

In some embodiments, the sampling of a plurality of varied stable grasps comprises initializing the grasped object in a random pose and sampling a plurality of fingertip positions of the robotic hand. In some embodiments, the sampling is based on a number of fingertip contacts on the grasped object.

In some embodiments, the finger-gaiting and finger-grasping policies for each axis of rotation are combined.

In some embodiments, the proprioceptive sensing provides current positions and controller set-point positions of the robotic hand. In some embodiments, the robotic hand is a fully-actuated and position-controlled robotic hand.

In some embodiments, a reward function associated with a critic of the simulator is based on the angular velocity of a grasped object along a desired axis of rotation. In some embodiments, a reward function associated with a critic of the simulator is based on the number of fingertip contacts on a grasped object and the separation between a desired and a current axis of rotation.

### BRIEF DESCRIPTION OF THE DRAWINGS

FIG. 1 shows a simplified schematic diagram of a system for model-free reinforcement learning, in accordance with an embodiment of the present subject matter.

FIG. 2 shows a simplified schematic diagram of a system for model-free reinforcement learning, in accordance with an embodiment of the present subject matter.

FIG. 3 shows a learned finger gating policy that can continuously reorient the target object about the hand z-axis in accordance with an embodiment of the present subject matter.

FIG. 4 shows a hand-centric decomposition of in-hand re-orientations into re-orientation about cardinal axes in accordance with an embodiment of the present subject matter. Four view of hand in different positions.

FIG. 5 shows a learning axis conditional continuous re-orientation k\hat{ } in accordance with an embodiment of the present subject matter.

FIG. 6(a) shows sampling fingertips around an object.

FIG. 6(b) shows diverse relevant initial grasps sampled for efficiency in accordance with an embodiment of the present subject matter.

FIG. 7 shows finger-gaiting and finger-pivoting policies of the invention achieve to re-orient about z-axis and x-axis respectively in accordance with an embodiment of the present subject matter. Key frames are shown for two objects, dodecahedron and cube.

FIG. 8(a) shows average returns for z-axis re-orientation, and FIG. 8(b) shows average returns for x-axis re-orientation. FIGS. 8(a)-(b) show that learning with wide range of initial graphs sampled via SGS succeeds while using a fixed initial state fails.

FIG. 9 shows the robustness of policies of the present invention with increasing sensor noise and perturbation forces on the object.

FIG. 10 shows the cross transfer scores for policies with and without qd in feedback.

FIG. 11 shows ablations holding out different components of feedback. For each experiment, dots in the observation vector shown above the training curve indicate which of the components of the observation vector are provided to the policy.

FIG. 12 shows an exemplary flow diagram of a method in accordance with an embodiment of the subject matter.

FIG. 13 shows a schematic diagram of a computing environment in accordance with an embodiment of the subject matter.

FIG. 14 shows images of a real robot hand demonstrating finger-gaiting manipulation of concave or elongate objects via proprioceptive and tactile feedback.

FIG. 15 shows object shapes for finger-gait learning according to the present disclosure. From left to right: easy, moderate, and hard categories.

FIG. 16 shows tree expansion performance for G-RRT and M-RRT. We plot the number of attempted tree expansions (i.e. iterations through the main loop, on a log scale) against the maximum object z-axis rotation achieved by any tree node so far. For G-RRT, we also plot performance for different values of Kₘₐₓ, the number of random actions tested at each iteration.

FIG. 17 shows training performance for our methods (G-RRT and M-RRT) and a number of baselines on the object categories shown in FIG. 15.

FIG. 18 shows training performance with different tree sizes. The training curves shown are for different set of reset states obtained from trees of varying sizes. We see that we need a sufficiently large tree with at least 10⁴ nodes to enable learning. However, training is most reliable with 10⁵ nodes.

FIG. 19 shows Ablation of policy feedback components for L-shaped object. We note that touch feedback is essential in the absence of object pose feedback, and also leads to faster learning in comparison with object pose feedback.

FIG. 20 shows key frames of the finger-gaiting in simulation and on the real hand for representative objects in simulation and on real hand.

### DETAILED DESCRIPTION

The following includes definitions of selected terms employed herein. The definitions include various examples and/or forms of components that fall within the scope of a term and that may be used for implementation. The examples are not intended to be limiting. Further, one having ordinary skill in the art will appreciate that the components discussed herein, may be combined, omitted or organized with other components or organized into different architectures.

A “processor”, as used herein, processes signals and performs general computing and arithmetic functions. Signals processed by the processor may include digital signals, data signals, computer instructions, processor instructions, messages, a bit, a bit stream, or other means that may be received, transmitted, and/or detected. Generally, the processor may be a variety of various processors including multiple single and multicore processors and co-processors and other multiple single and multicore processor and co-processor architectures. The processor may include various modules to execute various functions.

A “memory”, as used herein, may include volatile memory and/or non-volatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory may store an operating system that controls or allocates resources of a computing device.

A “disk” or “drive”, as used herein, may be a magnetic disk drive, a solid state disk drive, a floppy disk drive, a tape drive, a Zip drive, a flash memory card, and/or a memory stick. Furthermore, the disk may be a CD-ROM (compact disk ROM), a CD recordable drive (CD-R drive), a CD rewritable drive (CD-RW drive), and/or a digital video ROM drive (DVD-ROM). The disk may store an operating system that controls or allocates resources of a computing device.

A “bus”, as used herein, refers to an interconnected architecture that is operably connected to other computer components inside a computer or between computers. The bus may transfer data between the computer components. The bus may be a memory bus, a memory controller, a peripheral bus, an external bus, a crossbar switch, and/or a local bus, among others. The bus may also interconnects components using protocols such as Media Oriented Systems Transport (MOST), Controller Area network (CAN), Local Interconnect Network (LIN), among others.

A “database”, as used herein, may refer to a table, a set of tables, and a set of data stores (e.g., disks) and/or methods for accessing and/or manipulating those data stores.

An “operable connection”, or a connection by which entities are “operably connected”, is one in which signals, physical communications, and/or logical communications may be sent and/or received. An operable connection may include a wireless interface, a physical interface, a data interface, and/or an electrical interface.

A “computer communication”, as used herein, refers to a communication between two or more computing devices (e.g., computer, personal digital assistant, cellular telephone, network device) and may be, for example, a network transfer, a file transfer, an applet transfer, an email, a hypertext transfer protocol (HTTP) transfer, and so on. A computer communication may occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

An “agent”, as used herein, may refer to a “robotic hand.” Additionally, “setting” as used herein, may be used interchangeably with “environment”. A “feature” as used herein, may include a goal.

The aspects discussed herein may be described and implemented in the context of non-transitory computer-readable storage medium storing computer-executable instructions. Non-transitory computer-readable storage media include computer storage media and communication media. For example, flash memory drives, digital versatile discs (DVDs), compact discs (CDs), floppy disks, and tape cassettes. Non-transitory computer-readable storage media may include volatile and non-volatile, removable and non-removable media implemented in any method or technology for storage of information such as computer readable instructions, data structures, modules, or other data.

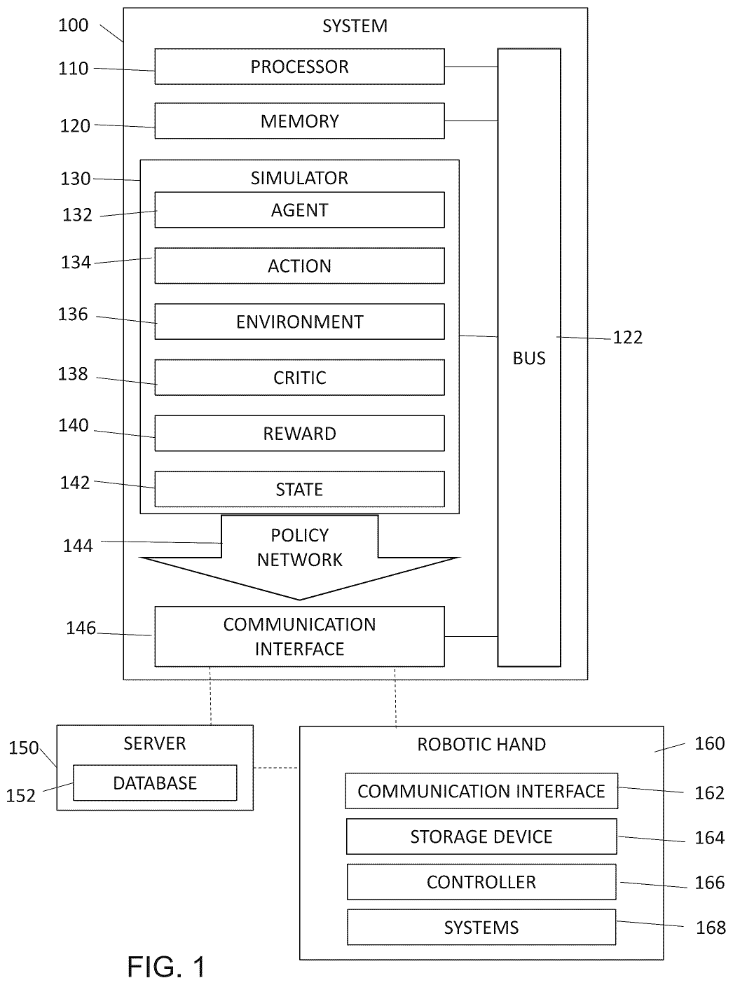

FIG. 1 is an exemplary component diagram of a system for model-free reinforcement learning, according to one aspect. The system 100 for generating a model-free reinforcement learning policy may include a processor 110, a memory 120, a bus 122 communicatively coupling one or more of the components of FIG. 1, and a simulator 130. The simulator 130 may be implemented via the processor 110 and the memory 120. The simulator 130 may simulate or perform simulation associated with one or more agents 132 (e.g., which may be a robotic hand), taking one or more actions 134, within a simulation environment 136, where one or more critics 138 interpret or evaluate one or more of the actions 134 taken by one or more of the agents 132 to determine one or more rewards 140 and one or more states 142 resulting from the actions taken.

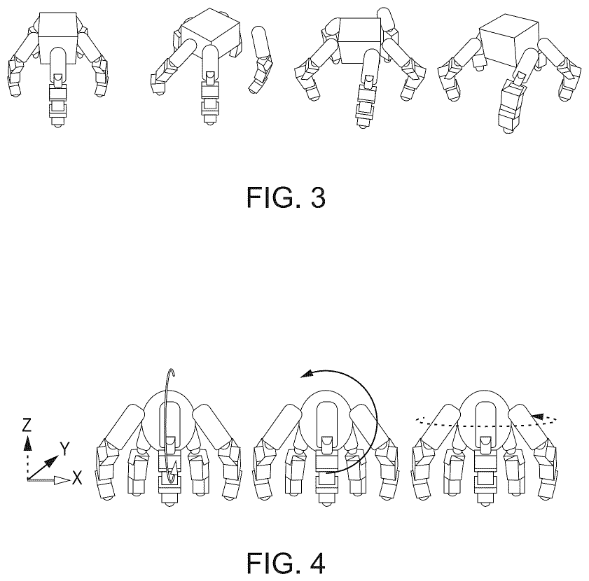

The simulator 130 or the processor 110 may generate a policy network 144, which may be stored on the memory 120 of the system 100 for generating a model-free reinforcement learning policy. The system may optionally further include a communication interface 146 which enables the policy network 144 to be transmitted to other devices, such as a server 150, which may include a database 152. In this way, the policy network 144 generated by the system 100 for generating a model-free reinforcement learning policy may be stored on the database 152 of the server 150. Discussion regarding greater detail associated with the building of the policy network 145 may be provided herein (e.g., FIGS. 3-7).

The server may then optionally propagate the policy network 144 to one or more robotic hands 160. The robotic hand may be equipped with a communication interface 162, a storage device 164, a controller 166, and one or finger manipulation systems 678, which may include actuators and/or sensors, for example. In some embodiments, the hands include the tactile sensors described in U.S. Pat. No. 10,663,362, which is incorporated by reference in its entirety herein. The storage device 164 may store the policy network 144 from the server, and the controller may operate the robotic hand in an autonomous fashion based on the policy network 144. In this way, the sensors of the robotic hand(s) may detect grasped objects and provide those as inputs (e.g., observations) to the policy network 144 developed by the simulator 130, which may then provide a suggested action for the robotic hand(s).

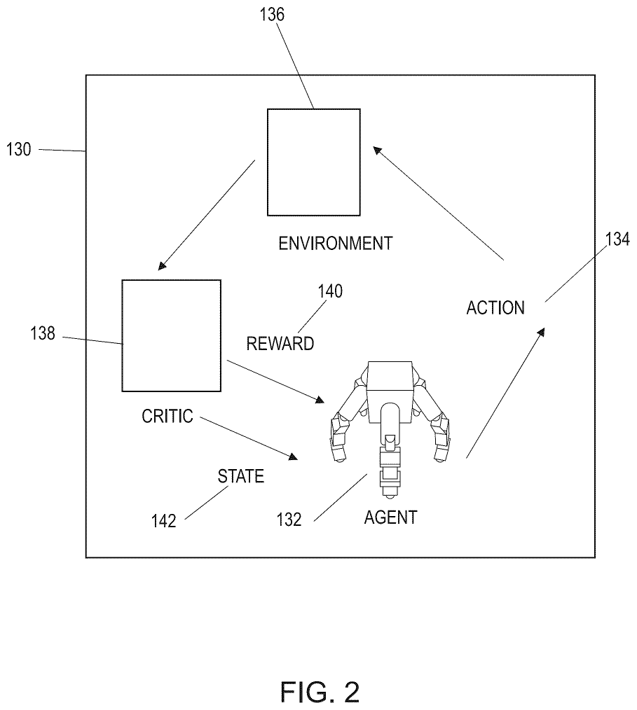

FIG. 2 is an exemplary component diagram of a system for model-free reinforcement learning of FIG. 1, according to one aspect. In FIG. 2, the simulator 130 of the system 100 for generating a model-free reinforcement learning policy of FIG. 1 may be seen. Here, the agent 132 may take the action 134 in the environment 136. This may be interpreted by the critic 138, as the reward 140 or penalty and a representation of the state 142, which may be then fed back into the agent 132. The agent 132 may interact with the environment 136 by taking the action 134 at a discrete time step. At each time step, the agent 132 may receive an observation which may include the reward 140. The agent 132 may determine an action 134, which results in a new state 142 and a new reward 140 for a subsequent time step. The goal of the agent 132 is generally to collect the greatest amount of rewards 140 possible.

In reinforcement learning, a model may refer to the different dynamic states of an environment and how these states lead to a reward. A policy may be a strategy generated to determine actions to take based on a current state. The overall outcome of reinforcement learning (or other types of learning) may be to develop a policy. Explained again, the policy may be a series of behaviors or actions to take when presented with a specific domain. Reinforcement may be applied by continually re-running or re-executing the learning process based on the results of prior learning, effectively updating an old policy with a newer policy to learn from the results and to improve the policy. In model based reinforcement learning, a model may be utilized to represent the environment or domain to indicate states and possible actions. By knowing states, the policies may target these states and actions specifically in each repetition cycle, testing and improving the accuracy of the policy, to improve the quality of the model. The policy, on the other hand, may be the learnings on the behaviors, where as the model may include the facts or scenario states that back up and confirm the learnings. According to one aspect, model-free reinforcement learning may be provided to build the policy. The policy may take information associated with grasping an object and output a suggestion action for the robotic hand, such as finger-gaiting and finger-pivoting, for example.

For in-hand manipulation, we use model-free deep reinforcement learning (RL), including learning finger-gaiting (manipulation involving finger substitution and re-grasping) and finger-pivoting (manipulation involving the object in hinge-grasp) skills. Both skills are important towards enabling large-angle in-hand object re-orientation: achieving an arbitrarily large rotation of the grasped object around a given axis, up to or even exceeding a full revolution. Such a task is generally not achievable by in-grasp manipulation (e.g., without breaking the contacts of the original grasp) and requires finger-gaiting or finger-pivoting (e.g., breaking and re-establishing contacts during manipulation); these are not restricted by the kinematic constraints of the hand and can achieve potentially limitless object re-orientation.

We are interested in achieving these skills exclusively through using fingertip grasps (e.g., precision in-hand manipulation) without requiring the presence of the palm underneath the object, which enables the policies to be used in arbitrary orientations of the hand. However, the task of learning to manipulate only via such precision grasps is a significantly harder problem: action randomization, responsible for exploration in RL, often fails as the hand can easily drop the object.

Furthermore, we would like to circumvent the need for cumbersome external sensing by only using internal sensing in achieving these skills. The challenge here is that the absence of external sensing implies we do not have information regarding the object such as its global shape and pose. However, internal sensing by itself can provide object information sufficient towards our goal.

Finger-gaiting and finger-pivoting skills can be achieved purely through intrinsic sensing in simulation, where we evaluate both proprioceptive feedback and tactile feedback. To this end, we consider the task of continuous object re-orientation about a given axis, aiming to learn finger-gaiting and finger-pivoting without object pose information. With this approach, we learn policies to rotate object about cardinal axes and combine them for arbitrary in-hand object re-orientation. To overcome challenges in exploration, we collect training trajectories starting from a wide range of grasps sampled from appropriately designed initial state distributions as an alternative exploration mechanism.

We learn finger-gaiting and finger-pivoting policies that can achieve large angle in-hand re-orientation of a range of simulated objects. Our policies learn to grasp and manipulate only via precision fingertip grasps using a highly dexterous and fully actuated hand, allowing us to keep the object in a stable grasp without the need for passive support at any instance during manipulation. We achieve these skills by making use of only intrinsic sensing such as proprioception and touch, while also generalizing to multiple object shapes. We present an exhaustive analysis of the importance of different internal sensor feedback for learning finger-gaiting and finger-pivoting policies in a simulated environment using our approach.

While a whole spectrum of methods have been considered for in-hand manipulation, online trajectory optimization methods and model-free deep RL methods stand out for highly actuated dexterous hands. Model-based online trajectory optimization methods have been exceptional in generating complex behaviors for dexterous robotic manipulation in general, but not for in-hand manipulation as these tasks fatally exacerbate their limitations: transient contacts introduce large non-linearities in the model, which also depends on hard-to-model contact properties.

Early work on finger-gaiting and finger-pivoting generally make simplifying assumptions such as 2D manipulation, accurate models, and smooth object geometries, which limit their versatility. Fan et al. and Sundaralingam et al. use model based online optimization and demonstrate finger-gaiting in simulation. These methods either use smooth objects or require accurate kinematic objects of the object and also challenging to transfer to real hand.

OpenAI et al. demonstrate finger-gaiting and finger-pivoting using RL, but as previously discussed, their policies cannot be used for arbitrary orientations of the hand. This can be achieved using only force-closed precision fingertip grasps but learning in-hand manipulation using only these grasps is challenging with few prior work. Li et al. learn 2D re-orientation using model-based controllers to ensure grasp stability in simulation. Veiga et al. demonstrate in-hand reorientation with only fingertips but these object centric policies are limited to small re-orientations via in-grasp manipulation and still require external sensing. Shi et al. demonstrate precision finger-gaiting but only on a lightweight ball. Morgan et al. also show precision finger-gaiting but with an under-actuated hand specifically designed for this task. We consider finger-gaiting with a highly actuated hand; our problem is exponentially harder due to increased degrees of freedom leading to poor sample complexity.

Some prior work use human expert trajectories to improve sample complexity for dexterous manipulation. However, these expert demonstrations are hard to obtain for precision in-hand manipulation tasks and even more so for non-anthropomorphic hands. Alternatively, model-based RL has also been considered for some in-hand manipulation tasks: Nagabandi et al. manipulate boading balls but use the palm for support; Morgan et al. learn finger-gaiting but with a task specific underactuated hand. However, learning a reliable forward model for precision in-hand manipulation with a fully dexterous hand can be challenging. Collecting data involves random exploration, which, as we discuss later in this paper, has difficulty exploring in this domain.

Prior work using model-free RL for manipulation rarely use tactile feedback as tactile sensing available on real hand is often high dimensional and hard to simulate. Hence, Hoof et al. propose learning directly on the real hand but this naturally limits us to tasks learnable on real hand. Alternatively, Veiga et al. learn a higher level policy through RL, while low level controllers exclusively deal with tactile feedback. However, this method deprives the policy from leveraging tactile feedback beneficial in other challenging tasks. While Melnik et al. show that using tactile feedback improves sample complexity in such tasks, they use high-dimensional tactile feedback with full coverage of the hand that is hard to replicate on a real hand. We instead consider low-dimensional tactile feedback covering only the fingertips.

Contemporary to our work, Chen et al. also show in-hand re-orientation without support surfaces that generalizes to novel objects. The policies exhibit complex dynamic behaviors including occasionally throwing the object and regrasping it in the desired orientation. We differ from this work as our policies only use sensing that is internal to the hand, and always keep the object in a stable grasp to be robust to perturbation forces at all times. Furthermore, our policies require a number of training samples that is smaller by multiple orders of magnitude, a feature that we attribute to efficient exploration via appropriate initial state distributions.

In the present subject matter, we address two important challenges for precision in-hand re-orientation using reinforcement learning. First, a hand-centric decomposition method achieves arbitrary in-hand re-orientation in an object agnostic fashion. Next, collecting training trajectories starting at varied stable grasps alleviates the challenge of exploration for learning precision in-hand manipulation skills. We use these grasps to design appropriate initial state distributions for training. Our approach assumes a fully-actuated and position-controlled (torque-limited) hand.

### Hand-Centric Decomposition

Our method relies on intrinsic sensing, and perform this in general fashion without assuming object knowledge. Thus, we do it in a hand-centric way: we learn to rotate around axes grounded in the hand frame. This means we do not need external tracking (which presumably needs to be trained for each individual object) to give us object-pose. We also find that rewarding angular velocity about desired axis of rotation is conducive to learning finger-gaiting and finger-pivoting policies. However, learning a single policy for any arbitrary axis is challenging as it involves learning goal-conditioned policies, which is difficult for model-free RL.

Our proposed method for wide arbitrary in-hand reorientation is to decompose the problem of achieving arbitrary angular velocity of the object into learning separate policies about the cardinal axes as shown in FIG. 4. The finger-gaiting policies for each axis thus obtained can then be combined in the appropriate sequence to achieve the desired change in object orientation while also side-stepping the difficulty of learning a goal-conditioned policy.

We assume that proprioceptive sensing can provide current positions q and controller set-point positions q_{d}. We note that the combination of desired positions and current positions can be considered as a proxy for motor forces, if the characteristics of the underlying controller are fixed. More importantly, we assume tactile sensing to provide absolute contact positions cⁱ∈ [symbol] ³ and normal forces tₙⁱ∈ [symbol] on each fingertip i. With known fingertip geometry, the contact normals \hat{t}ₙⁱ∈ [symbol] ³ can be derived from contact positions cⁱ.

Our axis-specific re-orientation policies are conditioned only on proprioceptive and tactile feedback as given by the observation vector o:

$$o = [ q , {q}_{d} , {c}^{1} … {c}^{m} , {t}_{n}^{1} … {t}_{n}^{m} , {\hat{t}}_{n}^{1} … {\hat{t}}_{n}^{m} ] \qquad ( 1 )$$

where m is the number of fingers. Our policies command set-point changes Δq_{d}

### Learning Axis-Specific Re-Orientation

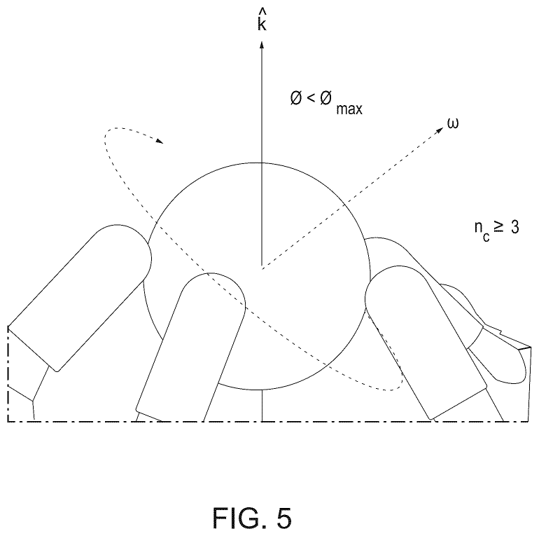

We now describe the procedure for learning in-hand reorientation policies for an arbitrary but fixed axis. Let \hat{k} be the desired axis of rotation. To learn axis-specific policy π^{\hat{k}} that continuously re-orients the object about the desired axis \hat{k} we use the object's angular velocity ω along \hat{k} as reward as shown in FIG. 5. However, to ensure that the policy learns to only use precision fingertip grasps to re-orient the object, we provide this reward if only fingertips are in contact with the object. In addition, we require that at least 3 fingertips are in contact with the object. Also, we encourage alignment of the object's axis of rotation with the desired axis by requiring the separation to be limited to φₘₐₓ.

$$r = min ( {r}_{max} , ω , \hat{k} ) I [ {n}_{c} \geq 3 ∧ ϕ \leq {ϕ}_{max} ] + min ( 0 , ω . \hat{k} ) I [ {n}_{c} < 3 ∨ ϕ > {ϕ}_{max} ]$$

The reward function is described in (2), where n_{c} is the number of fingertip contacts and φ is the separation between the desired and current axis of rotation. Symbols ∧, ∨, I are the logical and, the logical or, and indicator function, respectively. We also use reward clipping to avoid local optima and idiosyncratic behaviors. In our setup, rₘₐₓ and φₘₐₓ are both set to 0.5. Although the reward uses the object's angular velocity, we do not need additional sensing to measure it as we only train in simulation with the intent of zero-shot transfer to hardware.

Enabling Exploration with Domain Knowledge

A fundamental issue in using reinforcement learning for learning precision in-hand manipulation skills is that a random exploratory action can easily disturb the stability of the object held in precision grasp, causing it to be dropped. This difficulty is particularly acute for finger-gaiting, which requires fingertips to break contact with the object and transition between different grasps, involving different fingertips, all while re-orienting the object. Intuitively, the likelihood of selecting a sequence of random actions that can accomplish this feat and obtain a useful reward signal is very low.

For a policy to learn finger-gaiting, it may encounter these diverse grasps within its training samples so that the policy's action distributions can improve at these states. Consider taking a sequence of random actions starting from a stable l-finger grasp. While it is possible to reach a stable grasp with an additional finger in contact (if available), it is more likely to lose one finger contact, then another and so on until the object is dropped. Over multiple trials, we can expect to encounter most combinations of l1 grasps. In this setting, it can be argued that starting from a stable grasp with all m fingers in contact leads to maximum exploration.

Our insight is to observe that through domain knowledge we are already aware of the states that a sufficiently exploratory policy might visit. Thus, we use our knowledge of relevant states in designing the initial states used for episode rollouts and show that it is critical for learning precision finger-gaiting and finger-pivoting.

We sample sufficiently-varied stable grasps relevant to re-orienting the object about the desired axis and use them as initial states for collecting training trajectories. These grasps must be well distributed in terms of number of contacts, contact positions relative to the object, and object poses relevant to the task. To this end, we first initialize the object in a random pose and then sample fingertip positions until we find a stable grasp as described in Stable Grasp Sampling (SGS) in Alg. 1, below:

Algorithm 1 Stable Grasp Sampling (SGS)

| | |
|---|---|
| Input: ρ_{obj}, ρ_{hand}, tₛ, n_{c, min} | [symbol] object |

pose distribution, hand pose distribution, simulation settling time,
minimum number of contacts

| | |
|---|---|
| Output: s_{g} | [symbol] simulator state of the sampled grasp |
| 1. | repeat |
| 2. | Sample object and hand |
| | pose: xₛ~ρ_{obj} qₛ ~ρ_{hand} |
| 3. | Set object pose in the simulator with xₛ |
| 4. | Set joint positions and |
| | controller set-points with qₛ |
| 5. | Step the simulation forward by tₛ seconds |
| 6. | Find number of fingertips |
| | in contact with object n_{c} |
| 7. | until n_{c} ≥ n_{c, min} |
| 8. | Save simulator state as s_{g} |

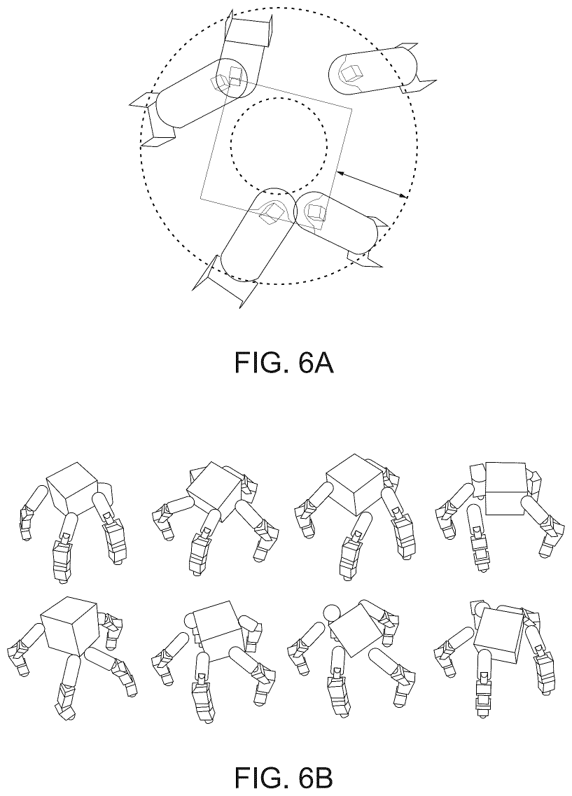

In SGS, we first sample an object pose and a hand pose, then update the simulator with the sampled poses towards obtaining a grasp. We advance the simulation for a short duration, tₛ, to let any transients die down. If the object has settled into a grasp with at least two contacts, the pose is used for collecting training trajectories. Note that the fingertips could be overlapping with the object or with each other as we do not explicitly check this. However, due to the soft-contact model used by the simulator (Emanuel Todorov, Tom Erez, and Yuval Tassa. “MuJoCo: A physics engine for model-based control”. 2012 IEEE/RSJ International Conference on Intelligent Robots and Systems. October 2012, pp. 5026-5033), the inter-penetrations are resolved during simulation. An illustrative set of grasps sampled by SGS are shown in FIG. 6(b).

To sample the hand pose, we start by sampling finger-tip locations within an annulus centered on and partially overlaps with the object, as shown in FIG. 6(a). Thus, the probabilities of each fingertip making contact with the object and of staying free are roughly the same. With this procedure, not only do we find stable grasps relevant to finger-gaiting and finger-pivoting, we improve the likelihood of discovering them, thus minimizing training wall-clock time.

### Experiments

For evaluating our method, we focus on learning precision in-hand re-orientation about the z- and x-axes for a range of regular object shapes. (The y-axis is similar to x-, given the symmetry of our hand model.) Our object set, which consists of a cylinder, sphere, icosahedron, dodecahedron and cube, is designed so that we have objects of varying difficulty with the sphere and cube being the easiest and hardest, respectively. For training, we use PPO (John Schulman, Filip Wolski, Prafulla Dhariwal, Alec Radford and Oleg Klimov. “Proximal Policy Optimization Algorithms” July 2017.) We chose PPO over other state-of-the-art methods such as SAC primarily for training stability

For the following analysis, we use z-axis re-orientation as a case study. In addition to the above, we also train z-axis re-orientation policies without assuming joint set-point feedback q_{d}. For all these policies, we study their robustness properties by adding noise and also by applying perturbation forces on the object. We also study the zero-shot generalization properties of these policies. Finally, through ablation studies we present a detailed analysis ascertaining the importance of different components of feedback for achieving finger-pivoting.

We note that, in simulation, the combination of q_{d} and q can be considered a good proxy for torque, since simulated controllers have stable and known stiffness. However, this feature might not transfer to a real hand, where transmissions exhibit friction, stiction and other hard to model effects. We thus evaluate our policies both with and without joint set-point observations.

### Learning Finger-Gaiting Manipulation

FIG. 6a shows the learning curves for object re-orientation about the z-axis for a range of objects from using our method of sampling stable initial grasps to improve exploration. We also show learning curves using a fixed initial state (grasp with all fingers) for representative objects. First, we notice that the latter approach does not succeed. These policies only achieve small re-orientation via in-grasp manipulation and drop the object after maximum re-orientation achievable without breaking contacts.

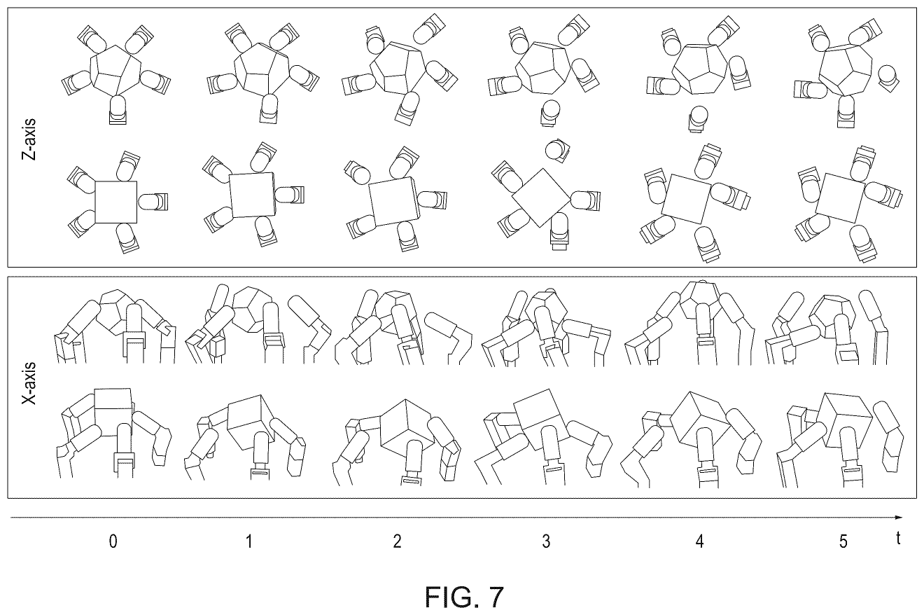

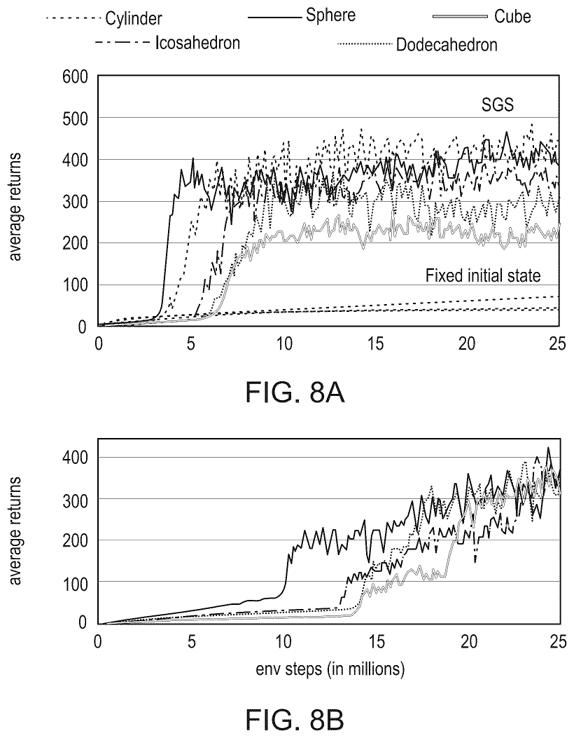

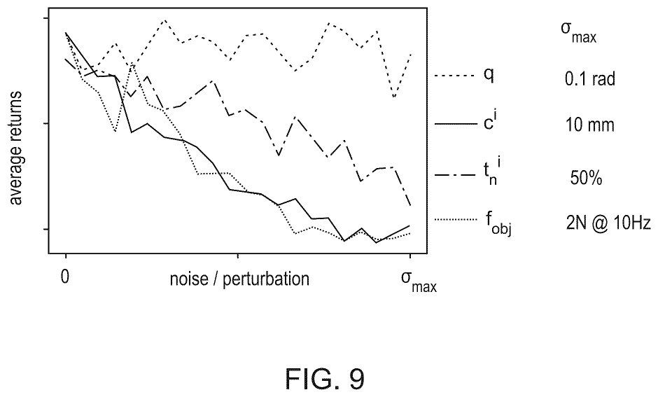

However, when using a wide initial distribution of grasps (sampled via SGS), the policies learn finger-gaiting and achieve continuous re-orientation of the object with significantly higher returns. With our approach, we also learn finger-pivoting for re-orientation about the x-axis, with learning curves shown in FIG. 6b. Thus, we empirically see that using a wide initial distribution consisting of relevant grasps is critical for learning continuous in-hand re-orientation and that our method results in superior sample-complexity over the state-of-the-art i.e. PPO without the use of initial state distribution. FIG. 7 shows the finger-gaiting and finger-pivoting policies performing continuous object re-orientation about z-axis and x-axis respectively.

As expected, difficulty of rotating the objects increases as we consider objects of lower rotational symmetry from sphere to cube. In the training curves in FIG. 6, we can observe this trend not only in the final returns achieved by the respective policies, but also in the number of samples required to learn continuous re-orientation.

We also successfully learn policies for in-hand re-orientation without joint set-point position feedback, but these policies achieve slightly lower returns. However, they may have interesting consequences for generalization as we will discuss in Sec IV-C.

### Robustness

FIG. 9 shows the performance of our policy for the most difficult object in our set (cube) as we artificially add white noise with increasing variance to different sensors' feedback. We also increasingly add perturbation forces on the object. Overall, we notice that our policies are robust to noise and perturbation forces of magnitudes that can be expected on a real hand

In particular, our policies show little drop in performance for noise in joint positions, but are more sensitive to noise in contact feedback. Nevertheless, they are still robust, and achieve high returns even at 5 mm error in contact position and 25% error in contact force. Interestingly, for noise in contact position, we found that drop in performance arises indirectly through the error in contact normal \hat{t}ₙⁱ (computed from contact position cₙⁱ). As for perturbation forces on the object, we observe high returns even for high perturbation forces (1N) equivalent to the weight of our objects. Our policies are robust event without joint-setpoint qd feedback with similar robustness profiles.

### Generalization

We study generalization properties of our policies by evaluating it on different objects in the object set. We consider the transfer score, which is the ratio Ry Ra where Ry is the average returns obtained when evaluating the policy learned with object i on object j

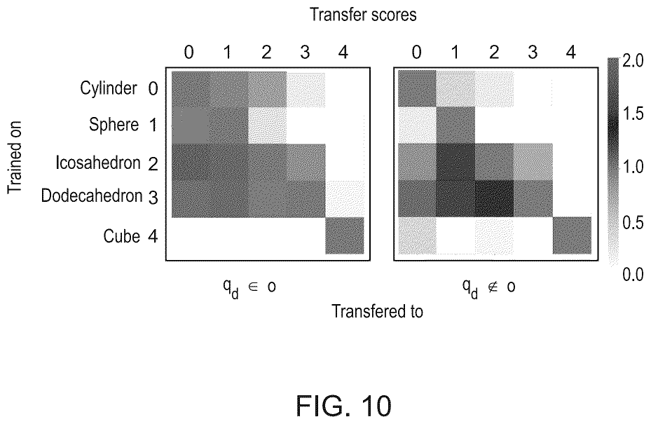

FIG. 10 shows the cross transfer performance for policies trained with all feedback. We note that the policy trained on the sphere transfers to the cylinder and vice versa. Also, the policies trained on icosahedron and dodecahedron transfer well between themselves and also perform well on sphere and cylinder. Interestingly, the policy trained on the cube does not transfer well to the other objects. When not using joint set-point position feedback q_{d}, the policy learned on the cube transfers to more objects. With no way to infer motor forces, the policy potentially learns to rely more on contact feedback which aids generalization.

### Observations on Feedback

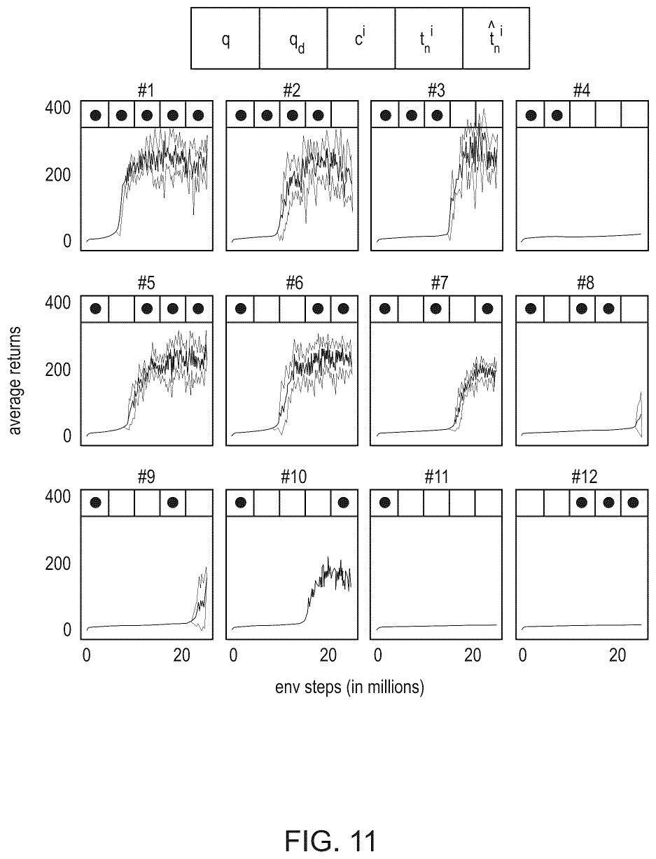

We are particularly interested to discover what aspects matter most in contact feedback. To answer such questions, we run a series of ablations holding out different components. For this, we again consider learning finger-gaiting on the cube as shown in FIG. 11.

Based on this ablation study, we can make a number of observations. As expected, contact feedback is essential for learning in-hand re-orientation via finger-gaiting; the policy does not learn finger-gaiting with just proprioceptive feedback (#4). More interesting, and also more surprising, is that explicitly computing contact normal tⁱ and providing it as feedback is critical when excluding joint position set-point q_{d} (#6 to #10). In fact, the policy learns finger-gaiting with just contact normal and joint position feedback (#10). However, while not critical, contact position and force feedback are still beneficial as they improve sample efficiency (#6, #7).

The techniques described herein focus on the problem of learning in-hand manipulation policies that can achieve large-angle object re-orientation via finger-gaiting. We consider sensing modalities intrinsic to the hand, such as touch and proprioception, with no external vision or tracking sensor providing object-specific information. Furthermore, we aim for policies that can achieve manipulation skills without using a palm or other surfaces for passive support, and which instead need to maintain the object in a stable grasp.

A component of our approach described herein is the use of appropriate initial state distributions during training, used to alleviate the intrinsic instability of precision grasping. We also decompose the manipulation problem into axis-specific rotation policies in the hand coordinate frame, allowing for object-agnostic policies. Combining these, we are able to achieve the desired skills in a simulated environment, the first instance in the literature of such policies being successfully trained with intrinsic sensor data.

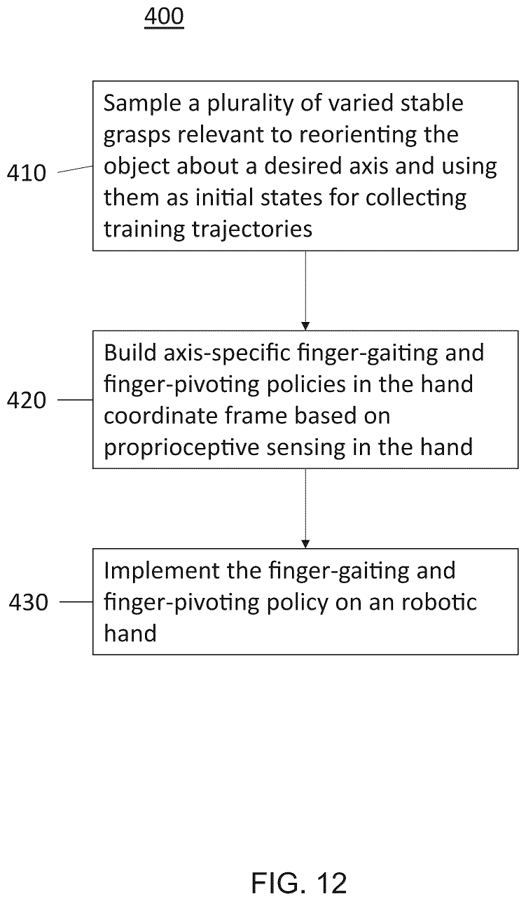

FIG. 12 is an exemplary flow diagram of a method 400 for model-free reinforcement learning, according to one aspect. The method 400 for model-free reinforcement learning may include sampling 410 a plurality of varied stable grasps relevant to reorienting the object about a desired axis and using them as initial states for collecting training trajectories, learning 420 axis-specific finger-gaiting and finger—grasping policies in the hand coordinate frame based on proprioceptive sensing in the hand, and implementing 430 the finger-gaiting and finger-pivoting policy on an robotic hand.

Still another aspect involves a computer-readable medium including processor-executable instructions configured to implement one aspect of the techniques presented herein. An aspect of a computer-readable medium or a computer-readable device includes a computer-readable medium, such as a CD-R, DVD-R, flash drive, a platter of a hard disk drive, etc., on which is encoded computer-readable data. This encoded computer-readable data, such as binary data including a plurality of zero's and one's, in turn includes a set of processor-executable computer instructions configured to operate according to one or more of the principles set forth herein. In this implementation, the processor-executable computer instructions may be configured to perform a method, such as the method 500 of FIG. 12. In another aspect, the processor-executable computer instructions may be configured to implement a system, such as the system 100 of FIG. 1. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processing unit, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

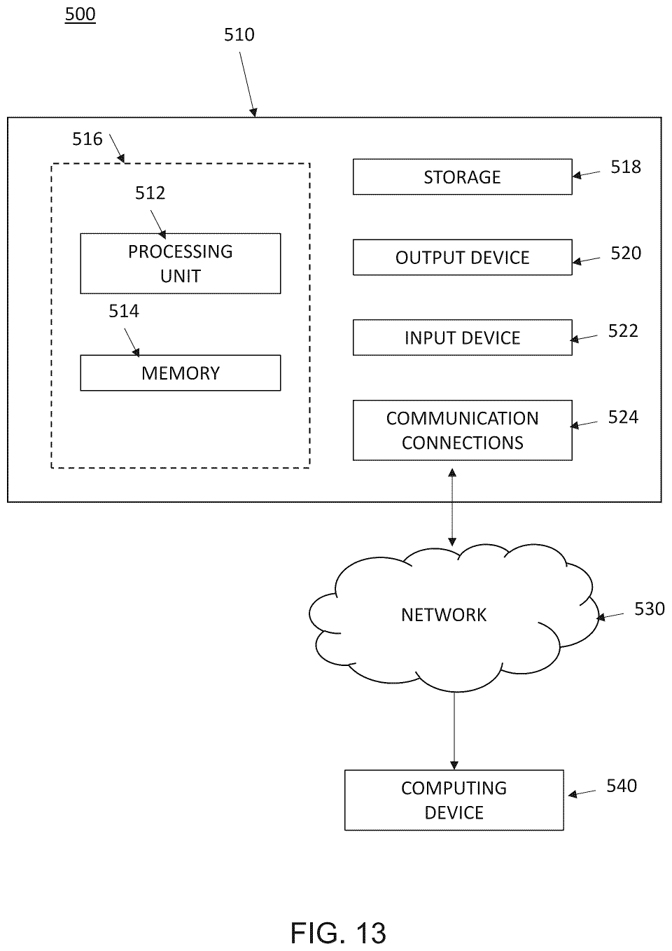

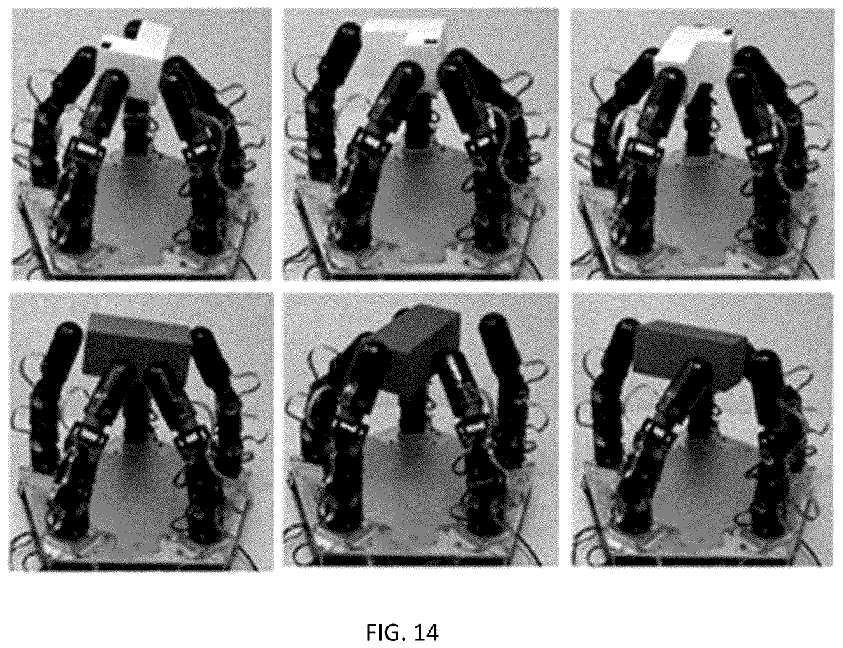

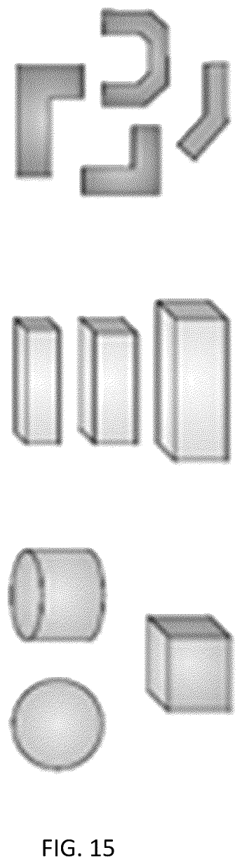

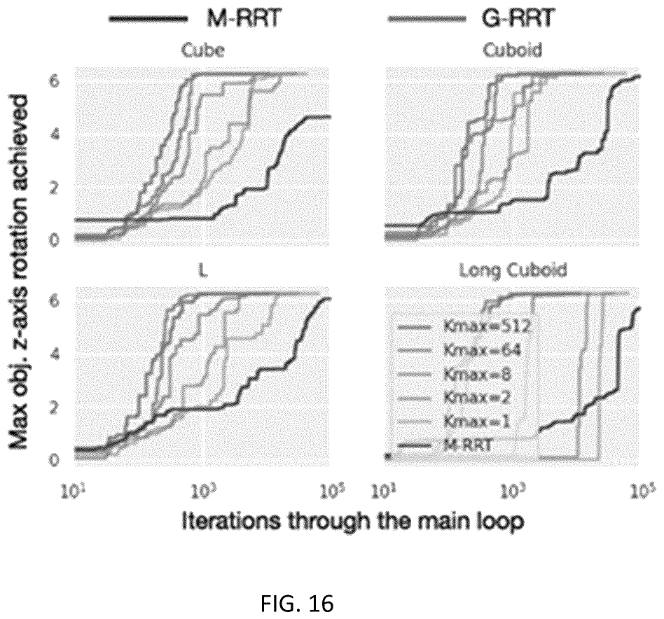

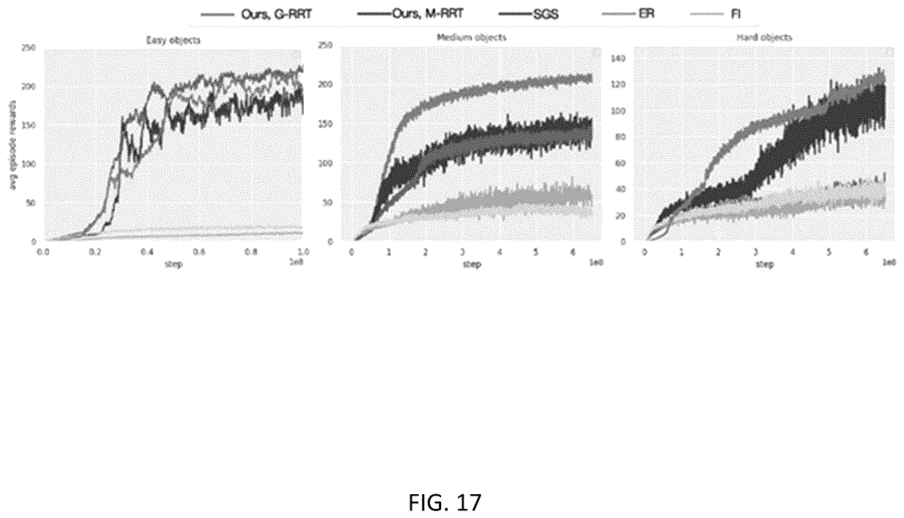

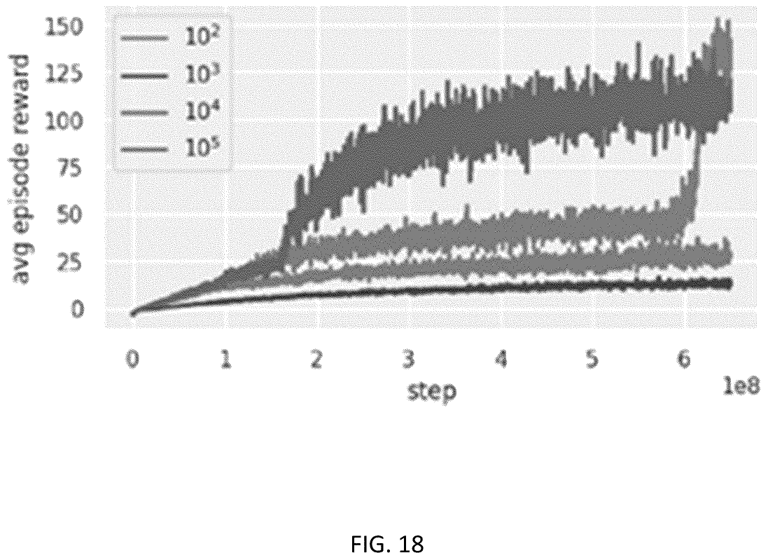

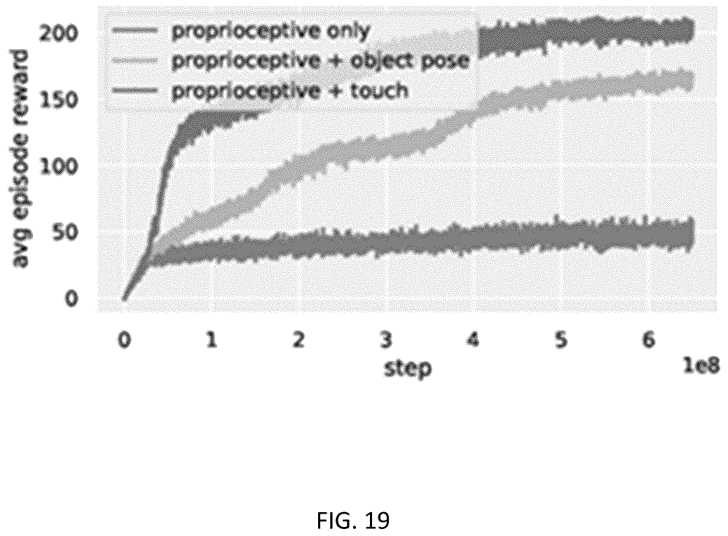

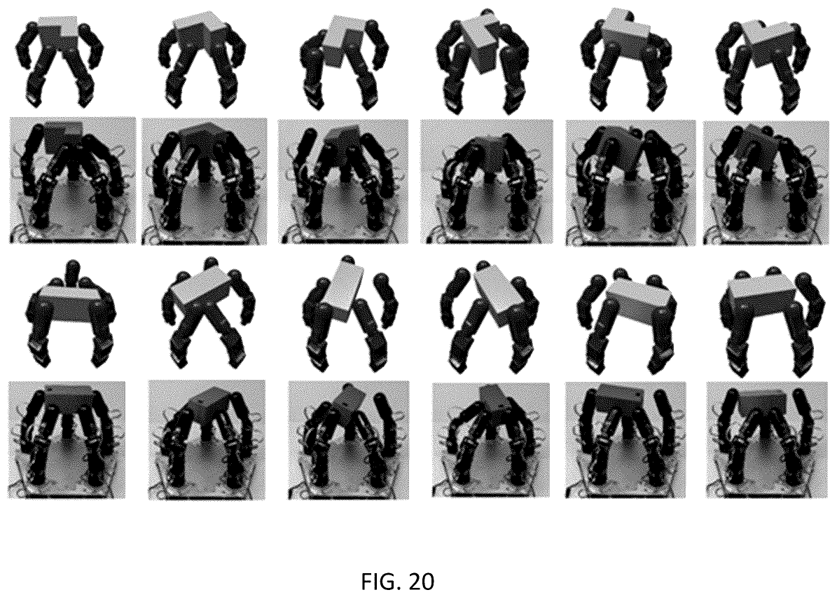

FIG. 13 and the following discussion provide a description of a suitable computing environment to implement aspects of one or more of the provisions set forth herein. The operating environment of FIG. 13 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, etc.

Generally, aspects are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, that perform one or more tasks or implement one or more abstract data types. Typically, the functionality of the computer readable instructions are combined or distributed as desired in various environments.

FIG. 13 illustrates a system 500 including a computing device 510 configured to implement one aspect provided herein. In one configuration, the computing device 510 includes at least one processing unit 512 and memory 514. Depending on the exact configuration and type of computing device, memory 514 may be volatile, such as RAM, non-volatile, such as ROM, flash memory, etc., or a combination of the two. This configuration is illustrated in FIG. 13 by dashed line 516.

In other aspects, the computing device 510 includes additional features or functionality. For example, the computing device 510 may include additional storage such as removable storage or non-removable storage, including, but not limited to, magnetic storage, optical storage, etc. Such additional storage is illustrated in FIG. 13 by storage 518. In one aspect, computer readable instructions to implement one aspect provided herein are in storage 518. Storage 518 may store other computer readable instructions to implement an operating system, an application program, etc. Computer readable instructions may be loaded in memory 514 for execution by processing unit 512, for example.

The term “computer readable media” as used herein includes computer storage media. Computer storage media includes volatile and nonvolatile, removable and non-removable media implemented in any method or technology for storage of information such as computer readable instructions or other data. Memory 514 and storage 518 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which may be used to store the desired information and which may be accessed by the computing device 510. Any such computer storage media is part of the computing device 510.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

The computing device 510 may include input device(s) 522 such as keyboard, mouse, pen, voice input device, touch input device, infrared cameras, video input devices, or any other input device. Output device(s) 520 such as one or more displays, speakers, printers, or any other output device may be included with the computing device 510. Input device(s) and output device(s) may be connected to the computing device 510 via a wired connection, wireless connection, or any combination thereof. In one aspect, an input device or an output device from another computing device may be used as input device(s) 522 or output device(s) 524 for the computing device 510. The computing device 912 may include communication connection(s) 524 to facilitate communications with one or more other devices 540, such as through network 530, for example.

### Manuscript: Sampling-Based Exploration for Reinforcement Learning of Dexterous Manipulation

Reinforcement Learning (RL) of robot sensorimotor control policies has seen great advances in recent years, demonstrated for a wide range of motor tasks. In the case of manipulation, this has translated in higher levels of dexterity than previously possible, typically demonstrated by the ability to re-orient a grasped object in-hand using complex finger movements. However, training a sensorimotor policy is still a difficult process, particularly for problems where the underlying state space exhibits complex structure, such as “narrow passages” between parts of the space are accessible or useful. Manipulation is indeed such a problem: even when starting with the object secured between the digits, a random action can easily lead to a drop, and thus to an irrecoverable state. Finger-gaiting further implies transitions between different subsets of fingers used to hold the object, all while maintaining stability. This leads to difficulty in exploration during training, since random perturbations in the policy action space are unlikely to discover narrow passages in state space. Current studies address this difficult through a variety of means: using simple, convex objects to reduce the difficulty of the task, reliance on support surfaces to reduce the chances of a drop, object pose tracking through extrinsic sensing, etc.

The difficulty of exploring problems with labyrinthine state space structure is far from new in robotics. In fact, the large and highly effective family of Sampling-Based Planning (SBP) algorithms was developed in the field to address this exact problem. By expanding a known structure towards targets randomly sampled in the state space of the problem (as opposed to the action space of the agent), SBP methods can explore even very high-dimensional state spaces in ways that are probabilistically complete, or guaranteed to converge to optimal trajectories. However, SBP algorithms are traditionally designed to find trajectories rather than policies. For problems with computationally demanding dynamics, SBP can not be used on-line for previously unseen start states, or to quickly correct when unexpected perturbations are encountered along the way.

In this paper, we draw on the strength of both RL and SBP methods in order to train motor control policies for in-hand manipulation with finger gaiting. We aim to manipulate more difficult objects, including concave shapes, while securing them at all times without relying on support surfaces. Furthermore, we aim to achieve large re-orientation of the grasped object with purely intrinsic (tactile and proprioceptive) sensing. To achieve that, we explore multiple variants of the non-holonomic RRT algorithm with added constraints to find (approximate) trajectories that explore the useful parts of the problem state space. Then, we use these trajectories as reset distributions to train complete RL policies based on the full dynamics of the problem. Overall, the main contributions of this work include:
To the best of our knowledge, we are the first to show that reset distributions generated via SBP with kinematic constraints can enable more efficient training of RL control policies for dexterous in-hand manipulation.
We show that SBP can explore useful parts of the manipulation state space by using either analytical approximations for contact and stability constraints, or by explicitly using the system's transition function (if available). When analytical approximations are used, RL later fills in the gaps by learning appropriate actions under more realistic dynamic constraints.
The exploration boost from SBP allows us to train policies for dexterous skills not previously shown, such as in-hand manipulation of concave shapes, with only intrinsic sensing and no support surfaces. We demonstrate these skills both in simulation and on real hardware.

### Related Work

Exploration methods for general RL operate under the strict assumption that the learning agent cannot teleport between states, mimicking the constraints of the real world. Under such constraints, proposed exploration methods include using intrinsic rewards or improving action consistency via temporally correlated noise in policy actions or parameter space noise.

Fortunately, in cases where the policies are primarily trained in simulation, this requirement can be relaxed, and we can use our knowledge of the relevant state space to design effective exploration strategies. A number of these methods improve exploration by injecting useful states into the reset distribution during training. Nair et al. use states from human demonstrations in a block stacking task, while Ecoffet et al. use states previously visited by the learning agent itself for problems such as Atari games and robot motion planning. Tavakoli et al. evaluate various schemes for maintaining and resetting from the buffer of visited states. However, these schemes were evaluated only on benchmark continuous control tasks. From a theoretical perspective, Agarwal et al. show that a favorable reset state distribution provides a means to circumvent worst-case exploration issues, using sample complexity analysis of policy gradients.

Finding feasible trajectories through a complex state space is a well-studied motion planning problem. Of particular interest to us are sampling-based methods such as Rapidly exploring Random Trees (RRT) and Probabilistic Road Maps (PRM). These families of methods have proven highly effective, and are still being expanded. Stable Sparse-RRT (SST) and its optimal variant SST* are examples of recent sampling-based methods for high-dimensional motion planning with physics. However, the goal of these methods is finding (kinodynamic) trajectories between known start and goal states, rather than closed-loop control policies which can handle deviations from the expected states.

Several approaches have tried to combine the exploratory ability of SBP with RL, leveraging planning for global exploration while learning a local control policy via RL. These methods were primarily developed for and tested on navigation tasks, where nearby state space samples are generally easy to connect by an RL agent acting as a local planner. The LeaPER algorithm also uses plans obtained by RRT as reset state distribution and learns policies for simple non-prehensile manipulation. However, the state space for the prehensile in-hand manipulation tasks we show here is highly constrained, with small useful regions and non-holonomic transitions. Other approaches use trajectories planned by SBP as expert demonstrations for RL, but this requires that planned trajectories also include the actions used to achieve transitions, which SBP does not always provide. Alternatively, Jurgenson et al. and Ha et al. use planned trajectories in the replay buffer of an off-policy RL agent for multi-arm motion planning. However, it is unclear how off-policy RL can be combined with the extensive physics parallelism that has been vital in the recent success of on-policy methods for learning manipulation.

Turning specifically to the problem of dexterous manipulation, a number of methods have been used to advance the state of the art, including planning, learning, and leveraging mechanical properties of the manipulator. Leveroni et al. build a map of valid grasps and use search methods to generate gaits for planar reorientation, while Han et al. consider finger-gaiting of a sphere and identify the non-holonomic nature of the problem. Some methods have also considered RRT for finger-gaiting in-hand manipulation, but limited to simulation for a spherical object. More recently, Morgan et al. demonstrate robust finger-gaiting for object reorientation using actor-critic reinforcement learning and multi-modal motion planning, both in conjunction with a compliant, highly underactuated hand designed explicitly for this task. Bhatt et al. also demonstrate robust finger-gaiting finger-pivoting manipulation with a soft compliant hand, but these skills were not autonomously learned but rather hand-designed and executed in an open-loop fashion.

Model-free RL has also led to significant progress in dexterous manipulation, starting with OpenAI's demonstration of finger-gaiting and finger-pivoting, trained in simulation and translated to real hardware. However, this approach uses extensive extrinsic sensing infeasible outside the lab, and relies on support surfaces such as the palm underneath the object. Khandate et al. show dexterous finger-gaiting and finger-pivoting skills using only precision fingertip grasps to enable both palm-up and palm-down operation, but only on a range of simple convex shapes and in a simulated environment. Makoviychuk et al. showed that GPU physics could be used to accelerate learning skills similar to OpenAI's. Allshire et al. used extensive domain randomization and sim-to-real transfer to re-orient a cube but used table top as an external support surface. Chen et al. demonstrated in-hand re-orientation for a wide range of objects under palm-up and palm-down orientations of the hand with extrinsic sensing providing dense object feedback. Sievers et al. and Pitz et al. demonstrated in-hand cube reorientation to desired pose with purely tactile feedback. Qi et al. used rapid motor adaptation to achieve effective sim-to-real transfer of in-hand manipulation skills for small cylindrical and cube-like objects. In our case, the exploration ability of SBP allows learning of policies for more difficult tasks, such as in-hand manipulation of non-convex and large shapes, with only intrinsic sensing. We also achieve successful, robust sim-to-real transfer without extensive domain randomization or domain adaptation, by closing the sim-to-real gap via tactile feedback.

### Method

In this paper, we focus on the problem of achieving dexterous in-hand manipulation while simultaneously securing the manipulated object in a precision grasp. Keeping the object stable in the grasp during manipulation is needed in cases where a support surface is not available, or the skill must be performed under different directions for gravity (i.e. palm up or palm down). However, it also creates a difficult class of manipulation problems, combining movement of both the fingers and the object with a constant requirement of maintaining stability. In particular, we focus on the task of achieving large in-hand object rotation, which we, as others before, believe to be representative of this general class of problems, since it requires extensive finger gaiting and object re-orientation.

### Problem Description

Formally, our goal is to obtain a policy for issuing finger motor commands, rewarded by achieving large object rotation around a given hand-centric axis. The state of our system at time t is denoted by xₜ=(qₜ, pₜ), where q∈ [symbol] ^{d} is a vector containing the positions of the hand's d degrees of freedom (joints), and p∈ [symbol] ⁶ contains the position and orientation of the object with respect to the hand. An action (or command) is denoted by the vector a∈ [symbol] ^{d} comprising new setpoints for the position controllers running at every joint.

For parts of our approach, we assume that a model of the forward dynamics of our environment (i.e. a physics simulator) is available for planning or training. We denote this model by xₜ+1=F (xₜ, aₜ). We will show however that our results transfer to real robots using standard sim-to-real methods.

We chose to focus on the case where the only sensing avail-able is hand-centric, either tactile or proprioceptive. Achieving dexterity with only proprioceptive sensing, as biological organisms are clearly capable of, can lead to skills that are robust to occlusion and lighting and can operate in very constrained settings. With this directional goal in mind, the observation available to our policy consists of tactile and proprioceptive data collected by the hand, and no global object pose information. Formally, the observation vector is

$${o}_{t} = [ {q}_{t} , {q}_{t}^{s} , {c}_{t} ] \qquad ( 1 )$$

where qₜ, qₜ^{s}∈ [symbol] ^{d} are the current positions and setpoints of the joints, and cₜ∈[0,1]^{m} is the vector representing binary (contact/no-contact) touch feedback for each of m fingers of the hand.

As discussed above, we also require that the hand maintain a stable precision grasp of the manipulated object at all times. Overall, this means that our problem is characterized by a high-dimensional state space, but only small parts of this state space are accessible for us: those where the hand is holding the object in a stable precision grasp. Furthermore, the transition function of our problem is non-holonomic: the subset of fingers that are tasked with holding the object at a specific moment, as well as the object itself, must move in concerted fashion. Conceptually, the hand-object system must evolve on the complex union of high-dimensional manifolds that form our accessible states. Still, the problem state space must be effectively explored if we are to achieve dexterous manipulation with large object re-orientation and finger gaiting.

### Manipulation RRT

To effectively explore our high-dimensional state space characterized by non-holonomic transitions, we turn to the well-known Rapidly-Exploring Random Trees (RRT) algorithm. We leverage our knowledge of the manipulation domain to induce tree growth along the desired manifolds in state space. In particular, we expect two conditions to be met for any state: (1) the hand must maintain at least three fingers in contact with the object, and (2) the distribution of these contacts must be such that a stable grasp is possible. We note that these are necessary, but not sufficient conditions for stability; nevertheless, we found them sufficient for effective exploration.

Preservation of condition (1) during the transition between two states means that the object and the fingers that maintain contact with it must move in unison. Assume that we would like the system to evolve from state xₛₜₐᵣₜ=(qₛₜₐᵣₜ, pₛₜₐᵣₜ) towards state x_{end}=(q_{end}, p_{end}), with a desired change in state of Δx_{des}=(Δq_{des}, Δp_{des})=x_{end}−xₛₜₐᵣₜ. Further assume that the set S comprises the indices of the fingers that are expected to maintain contact throughout the motion. The requirement of maintaining contact, linearized around xₛₜₐᵣₜ, can be expressed as:

$${J}_{S} ( {q}_{start} ) Δ {q}_{des} = {G}_{S} ( {p}_{start} ) Δ {p}_{des} \qquad ( 2 )$$

where J_{S} (qₛₜₐᵣₜ) is the Jacobian of contacts on fingers in set S computed at qₛₜₐᵣₜ, and G_{S} (pₛₜₐᵣₜ) is the grasp map matrix of contacts on fingers in set S computed at pₛₜₐᵣₜ. This is further equivalent to

$${N}_{S} ( {x}_{start} ) Δ {x}_{des} = 0 \qquad ( 3 )$$

where N_{S}(xₛₜₐᵣₜ)=[J_{S}(qₛₜₐᵣₜ)−G_{S}(pₛₜₐᵣₜ)]^{T}.

It follows that, if the desired direction of motion in state space Δx_{des} violates this constraint, we can still find a similar movement that does not violate the constraint by projecting the desired vector into the null space of the matrix N as defined above:

$$Δ {x}_{proj} = ( I - {N}^{T} N ) Δ {x}_{des} \qquad ( 4 )$$

$${x}_{new} = {x}_{start} + αΔ {x}_{proj} \qquad ( 5 )$$

where α is a constant determining the size of the step we are willing to take in the projected direction.

We note that this simple projection linearizes the contact constraint around the starting state. Even for small α, small errors due to this linearization can accumulate over multiple steps leading the fingers to lose contact. Thus, in practice, we further modify x_{new} by bringing back into contact with the object any finger that is within a given distance threshold (in practice, we set this threshold to 5 mm).

Maintaining at least three contacts with the object does not in itself guarantee a stable grasp. We take further steps to ensure that the contact distribution is appropriate for stability. Assume a set of k contacts, where each contact i has a normal direction nᵢ expressed in the global coordinate frame. We require that, if at least one contact j applies a non-zero normal contact force of magnitude cⱼ, the other contacts must be able to approximately balance it via normal forces of their own, minimizing the resulting net wrench applied to the object. This is equivalent to requiring that the hand have the ability to create internal object forces by applying normal forces at the existing contacts. We formulate this problem as a Quadratic Program:
unknowns: normal force magnitudes cᵢ, i=1 . . . k
minimize ∥w∥ subject to:

$$w = {{G}^{T} [ {c}_{1} {n}_{1} … {c}_{k} {n}_{k} ]}^{T} \qquad ( 6 )$$

$${c}_{i} \geq 0 ∀ i \qquad ( 7 )$$

$$∃ j such that {c}_{j} = 1 ( ensure non - zero solution ) \qquad ( 8 )$$

If the resulting minimization objective is below a chosen stability threshold, we deem the grasp to be stable:

$$If ‖ w ‖ < {ϵ}_{stab} : grasp is stable \qquad ( 9 )$$

We note that this measure is conservative in that it does not rely on friction forces. Furthermore, it ensure that the fingers are able to generate internal object forces using contact normal forces, but does not specify what are appropriate motor torques for doing so. Nevertheless, we have found it effective in pushing exploration towards useful parts of the state space. We can now put together these constraints into the complete algorithm shown in Alg. 1 and referred to in the rest of this paper as M-RRT. The essence of this algorithm is the forward propagation in lines 7-11. Given a desired direction of movement in state space, we want to ensure that at least three fingers maintain contact with the object. We thus project the direction of motion onto each of the manifolds defined by the contact constraints of each possible set of three fingers that begin the transition in contact with the object. We then choose the projected motion that brings us closest to the desired state-space sample. Finally, we perform an analytical stability check on the new state in line 9 via eqs. (6-9).

Algorithm 1 Manipulation RRT (M-RRT)

Require: Tree contains root node; N ← 1

| | |
|---|---|
| 1: | while N < Nₘₐₓ do |
| 2: | xₛₐₘₚₗₑ ← random point in state space |
| 3: | x_{node} ← node closest to xₛₐₘₚₗₑ currently in tree |
| 4: | Δx_{des} ← \|\| xₛₐₘₚₗₑ − x_{node} \|\| |
| 5: | S ← all sets of three fingers contacting the object in state x_{node} |
| 6: | dₘᵢₙ ← ∞; x_{new} ← NULL |
| 7: | for all Sᵢ in S do |
| 8: | Compute xᵢ by projecting Δx_{des} on the constraint manifold |
| | of contacts in Sᵢ as in |

eqs. (4-5)

| | |
|---|---|
| 9: | if Stable(xᵢ) and dist(xₛₐₘₚₗₑ, xᵢ) < dₘᵢₙ then |
| 10: | dₘᵢₙ ← dist(xₛₐₘₚₗₑ, xᵢ) |
| 11: | x_{new} ← xᵢ |
| 12: | if x_{new} is not NULL then |
| 13: | Add x_{new} to tree with x_{node} as parent |
| 14: | N ← N + 1 |

We note that M-RRT does not make use of the environment's transition function F ( ) (i.e. system dynamics). In fact, both the projection method in eqs. (4-5) and the stability check via eqs. (6-9) can be considered as approximations of the transition function, aiming to preserve movement constraints but without explicitly computing and checking the system's dynamics. As such, they are fast to compute but approximate in nature. It is possible that some of the transitions in the resulting RRT tree are in fact invalid under full system dynamics, or require complex sequences of motor actions. As we will see in Sec. III-D however, they are sufficient for helping learn a closed-loop control policy. Furthermore, for cases where the F ( ) is available and fast to evaluate, we also study a variant of our approach that makes explicit use of it in the next section.

### General-Purpose Non-Holonomic RRT

For problems where system dynamics F ( ) are available and fast to evaluate, we also investigate the general non-holonomic version of the RRT algorithm, which is able to determine an action that moves the agent towards a desired sample in state space via random sampling. Alg. 2 below is referred to as G-RRT.

The essence of this algorithm is the while loop in line 5: it is able to grow the tree in a desired direction by sampling a number Kₘₐₓ of random actions, then using the transition function F ( ) of our problem to evaluate which of these produces a new node that is as close as possible to a sampled target.

Algorithm 2 General-purpose non-holonomic RRT (G-RRT)

| Require: Tree contains root node; N ← 1 | |
|---|---|
| 1: | while N < Nₘₐₓ do |
| 2: | xₛₐₘₚₗₑ ← random point in state space |
| 3: | x_{node} ← node closest to xₛₐₘₚₗₑ currently in tree |
| 4: | dₘᵢₙ ← ∞; x_{new} ← NULL |
| 5: | while k < Kₘₐₓ do |
| 6: | a ← random action |
| 7: | xₐ ← F (x_{node}, a) |
| 8: | if Stable(xₐ) and dist(xₛₐₘₚₗₑ, xₐ) < dₘᵢₙ then |
| 9: | dₘᵢₙ ← dist(xₛₐₘₚₗₑ, xₐ) |
| 10: | x_{new} ← xₐ |
| 11: | k ← k + 1 |
| 12: | if x_{new} is not NULL then |
| 13: | Add x_{new} to tree with x_{node} as parent |
| 14: | N ← N + 1 |

Our only addition to the general-purpose algorithm is the stability check in line 8: a new node gets added to the tree only if it passes a stability check. This check consists of advancing the simulation for an additional Is with no change in the action; if, at the end of this interval, the object has not been dropped (i.e. the height of the object is above a threshold) the new node is deemed stable and added to the tree. Assuming a typical simulation step of 2 ms, this implies 500 additional calls to F ( ) for each sample; however, it does away with the need for domain-specific analytical stability methods as we used for M-RRT.

Overall, the great advantage of this algorithm lies in its simplicity and generality. The only manipulation-specific component is the aforementioned stability check. However, its performance can be dependent on Kₘₐₓ (i.e. number of action samples at each iteration), and each of these samples requires a call to the transition function. This problem can be alleviated by the advent of highly efficient and massively parallel physics engines implementing the transition function, which is an important research direction complementary to our study.

### Reinforcement Learning

While the RRT algorithms we have discussed so far have excellent abilities to explore the complex state space of in-hand manipulation, and to identify (approximate) transitions that follow the complex manifold structure of this space, they do not provide directly usable policies. In fact, M-RRT does not provide actions to use, and the transitions might not be feasible under the true transition function. G-RRT does find transitions that are valid, and also identifies the associated actions, but provides no mechanism to act in states that are not part of the tree, or to act under slightly different transition functions.

In order to generate closed-loop policies able to handle variability in the encountered states, we turn to RL algorithms. Critically, we rely on the trees generated by our sampling-based algorithms to ensure effective exploration of the state space during policy training. The specific mechanism we use to transition information from the sampling based tree to the policy training method is via the reset distribution: we select relevant paths from the planned tree, then use the nodes therein as reset states for policy training.

We note that the sampling-based trees as described here are task-agnostic. Their effectiveness lies in achieving good coverage of the state space (usually within pre-specified limits along each dimension). Once a specific task is prescribed (e.g. via a reward function), we must select the paths through the tree that are relevant for the task. For the concrete problem chosen in this paper (large in-hand object reorientation) we rely on the heuristic of selecting the top ten paths from the RRT tree that achieve the largest angular change for the object around the chosen rotation axis. (Other selection mechanisms are also possible; a promising and more general direction for future studies is to select tree branches that accumulate the highest reward.) After selecting the task-relevant set of states from the RRT tree, we use a uniform distribution over these states as a reset distribution for RL.

Our approach is compatible with RL methods that alternate between collecting episode rollouts and updating the policy, and restarting episode rollouts starting from a new set of states. Thus, both off-policy and on-policy RL are equally feasible. However, we use on-policy learning due to its compatibility with GPU physics simulators and relative training stability.

### Experiments and Results

We use the robot hand shown in FIG. 1, consisting of five identical fingers. Each finger comprises a roll joint and two flexion joints, for a total of 15 fully actuated position-controlled joints. For the real hardware setup, each joint is powered by a Dynamixel XM430-210T servo motor. The distal link of each finger consists of an optics-based tactile fingertip as introduced by Piacenza et al.

We test our methods on the object shapes illustrated in FIG. 2. We split this into categories: “easy” objects (sphere, cube cylinder), “moderate” objects (cuboids with elongated aspect ratios), and “hard” objects (either concave L- or U-shapes). We note that in-hand manipulation of the objects in the “hard” category has not been previously demonstrated in the literature.
1) Exploration Trees Setup: We run both G-RRT and M-RRT on the objects in our set. The first test consists, for both algorithms, in how effectively the tree explores its available state space given the number of iterations through the main loop (i.e. the number of attempted tree expansions towards a random sample). As a measure of tree growth, we look at the maximum object rotation achieved around our target axis. (We note that any rotation beyond approximately π/4 radians can not be done in-grasp, and requires finger repositioning.) Thus, for both algorithms, we compare maximum achieved object rotation vs. number of expansions attempted (on log scale). The results are shown in FIG. 3.

We found that both algorithms are able to effectively explore the state space. G-RRT is able to explore farther with fewer iterations, and its performance further increases with the number of actions tested at each iteration. We attribute this difference to the fact that M-RRT is constrained to taking small steps due to the linearization of constraints used in the extension projection. G-RRT, which uses the actual physics of the domain to expand the tree, is able to take larger steps at each iteration without the risk of violating the manipulation constraints.

As expected, the performance of G-RRT improves with the number Kₘₐₓ of actions tested at each iteration. Interestingly, the algorithm performs well even with Kₘₐₓ=1; this is equivalent to a tree node growing in a completely random direction, without any bias towards the intended sample. However, we note that, at each iteration, the node that grows is the closest to the state-space sample taken at the beginning of the loop. This encourages growth at the periphery of the three and along the real constraint manifolds, and, as shown here, still leads to effective exploration.

Both these algorithms can be parallelized at the level of the main loop (line 1). However, the extensive sampling of possible actions, which is the main computational expense of G-RRT (line 5) also lends itself to parallelization. In practice, we use the IsaacGym parallel simulator to parallelize this algorithm at both these levels (32 parallel evaluations of the main loop, and 512 parallel evaluations of the action sampling loop). This made both algorithms practical for testing in the context of RL.

We then moved on to using paths from the planned trees in conjunction with RL training. Since our goal is finger gaiting for z-axis rotation, we planned additional trees with each method where object rotation around the x- and y-axes was restricted to 0.2 radians. Then, from each tree, we select 2×10⁴ nodes from the paths which exhibit the most rotation around the z-axis, and extract their nodes. On average, each such path comprises 100-400 nodes. In the case of G-RRT, we recall that all tree nodes are subjected to an explicit stability check under full system dynamics before being added to the tree; we can thus use each of them as is. If using M-RRT, we also apply the same stability check to the nodes of the longest paths at this time, before using them as reset states for RL as described next.
2) Reinforcement Learning Setup: We train our policies using Asymmetric Actor Critic PPO; all training is done in the IsaacGym simulator. The critic uses object pose p, object velocity p′, and net contact force on each fingertip t₁ . . . tₘ as feedback in addition to the feedback already as input to the policy network. Similar to Khandate et al., we use a reward function that rewards object angular velocity about z-axis if the hand re-orienting the object with at least three fingertip contacts. In addition, we include penalties for the object's translational velocity and its deviation from the initial position. We also use early termination to terminate the episode rollout if there are fewer than two contacts.

### Experimental Conditions and Baselines

In our experiments, we compare the following approaches:
1) Ours, G-RRT: In this variant, we use the method presented in this paper, relying on exploratory reset states obtained by growing the tree via G-RRT. In all cases, we use a tree comprising 10⁵ nodes as informed the ablation study in FIG. 5.
2) Ours, M-RRT: This is also the method presented here, but using M-RRT for exploration trees. Again, we use trees comprising 10⁵ nodes.
3) Stable Grasp Sampler (SGS): This baseline represents an alternative to the method presented in this paper: we use a reset distribution consisting of stable grasps generated by sampling random joint angles and varying object orientation about the rotation axis. This approach has been demonstrated precision in-hand manipulation with only intrinsic sensing for simple shapes.
4) Explored Restarts (ER): This method selects states explored by the policy itself during random exploration to use as reset states. It is highly general, with no manipulation-specific component, and requires no additional step on top of RL training. We implement the “uniform restart” scheme as it was shown to have superior performance on high dimensional continuous control tasks. However, we have found it to be insufficient for the complex state space of our problem: it fails to learn a viable policy even for simple objects.)

Fixed Initialization (FI): For completeness, we also tried restarting training from a single fixed state. As expected, this method also failed to learn even in the simple cases. Addition-ally, we evaluated fixed initialization with gravity curriculum (zero to full). The policy only learned in-grasp manipulation, reorienting the object by the maximum possible amount with-out breaking contact before dropping. We found that the policy did not learn finger-gaiting even with zero gravity when using a fixed initialization. Thus, fixed initialization with or without gravity curriculum learning does not help with learning finger-gaiting. We hypothesize that curriculum learning has limited power to address exploration issues because policies tend to converge to sub-optimal behaviors that are hard to overcome later in training.

### Results

Training results are summarized FIG. 4. The performance on easy objects confirms the results of previous studies, which showed that a reset distribution consisting of random grasps (SGS) enables learning of rotation gaits; sampling-based exploration (our methods) achieves similar performance. For medium objects, G-RRT, M-RRT, and SGS again all learn to gait, but the policies learned via G-RRT exploration are more effective. Finally, for complex problems (hard objects), a random grasp-based reset distribution is no longer workable. Only G-RRT and M-RRT are able to learn manipulation, and G-RRT does so more efficiently. We also note that none of the domain-agnostic methods (ER and FI) are able to learn in-hand manipulation on any object set, in the allotted training time.

We also studied the impact of size of the tree used in extracting reset states. FIG. 5 summarizes our results for learning a policy for an L-shaped object using tree of different sizes grown via G-RRT. Qualitatively, we observe that, as the tree grows larger, the top 100-400 paths sampled from the tree contain increasingly more effective gaits, likely closer to the optimal policy. This suggests a strong correlation between the optimality of states used for reset distribution and sample efficiency of learning.

In addition, we performed an ablation study of policy feed-back. Particularly, we aimed to compare intrinsically available tactile feedback vs. object pose feedback that would require external sensing. FIG. 6 summarizes these results for an L-shaped object. First, we found that touch feedback is essential for all moderate and hard objects in the absence of object pose feedback. For these objects, we also saw that replacing this tactile feedback with object pose feedback results in slower learning, underscoring the importance of touch feedback for in-hand manipulation skills. Richer tactile feedback such as contact position, normals, and force magnitude can be expected to provide even stronger improvements; we hope to explore this in future work.

### Evaluation on Real Hand

To test the applicability of our method on real hardware, we attempted to transfer the learned policy for a subset of representative objects: cylinder, cube, cuboid & L-shape. We chose these objects to span the range from simpler to more difficult manipulation skills.

For sim-to-real transfer, we take a number of additional steps. We impose velocity and torque limits in the simulation, mirroring those used on the real motor (0.6 rad/s and 0.5 N-m respectively). We found that our hardware has significant latency of 0.05 s which we included in the simulation. In addition, we modified the angular velocity reward to maintain a desired velocity instead of maximizing the object's angular velocity. We also randomize joint origins (0.1 rad), friction coefficient (1-40), and train with perturbation forces (1N). All these changes are introduced successively via a curriculum.

For sensing, we used the current position and setpoint from the motor controllers with no additional changes. For tactile data, we found that information from our tactile fingers is most reliable for contact forces above 1 N. We thus did not use reported contact data below this threshold, and imposed a similar cutoff in simulation. Overall, we believe that a key advantage of exclusively using proprioceptive data is a smaller sim-to-real gap compared to extrinsic sensors such as cameras. For the set of representative objects, we ran the respective policy ten consecutive times, and counted the number of successful complete object revolutions achieved before a drop. In other words, five revolutions means the policy successfully rotated the object for 1, 800° before dropping it. In addition, we also report the average object rotation speed observed during the trials. The results of these trials are summarized in Table I. FIG. 7 shows the keyframes of the finger-gaiting we achieved by the policy on the hand and also compared it with manipulation observed in simulation.

### Discussion and Conclusion

The results we have presented show that sampling-based exploration methods make it possible to achieve difficult manipulation tasks via RL. In fact, these popular and widely used classes of algorithms are highly complementary in this case. RL is effective at learning closed-loop control policies that maintain the local stability needed for manipulation, and, thanks to training on large number of examples, are robust to variations in the encountered states. However, the standard RL exploration techniques (random perturbations in action space) are ineffective in the highly constrained state space with complex manifold structure of manipulation tasks. Conversely, SBP methods, which rely on a fundamentally different approach to exploration, can effectively discover relevant regions of the state space, and convey this information to RL training algorithms, for example via an informed reset distribution.

TABLE I
Manipulation performance in simulation vs. real hardware.
We report median number of object rotations achieved
before dropping the object in ten consecutive trials,
as well as the time needed to perform these rotations.

| | Median revolutions | Mean rotation speed (rad/s) |
|---|---|---|
| Cylinder | 5 | 0.42 |
| Cube (s) | 4.5 | 0.44 |
| Cuboid | 1.5 | 0.44 |
| L-shape | 1.5 | 0.24 |

Since sampling-based exploration methods are not expected to generate directly usable trajectories, exploration can also use approximate models of physical constraints, which can be informed by well-established analytical models of robotic manipulators. Interestingly, we found that using the general-purpose exploration algorithm using the full transition function of the environment is still more sample-efficient than using such analytical constraint models. Nevertheless, both are usable in practice, particularly with the advent of massively parallel physics simulators.

We use this approach to demonstrate finger gaiting precision manipulation of both convex and non-convex objects, using only tactile and proprioceptive sensing. Using only these types of intrinsic sensors makes manipulation skills insensitive to occlusion, illumination or distractors, and reduces the sim-to-real gap. We take advantage of this by demonstrating our approach both in simulation and on real hardware. We note that, while some applications naturally preclude the use of vision (e.g. extracting an object from a bag), we expect that in many real-life situations future robotic manipulators will achieve the best performance by combining touch, proprioception and vision. Learning in-hand object reorientation to achieve a given desired pose may also potentially benefit from our approach, for example by leveraging information from the RRT tree to find appropriate trajectories for reaching a specific node. Another more general and promising direction for future work involves other mechanisms by which ideas from sampling-based exploration can facilitate RL, beyond reset distributions. Some SBP algorithms can also be used to suggest possible actions for transitions between regions of the state space, a feature that we do not take advantage of here (even though one of the exploration algorithms we use does indeed compute actions). Alternatively, sampling-based exploration techniques could be integrated directly into the policy training mechanisms, removing the need for two separate stages during training. We hope to explore all these ideas in future work.

Although the subject matter has been described in language specific to structural features or methodological acts, it is to be understood that the subject matter of the appended claims is not necessarily limited to the specific features or acts described above. Rather, the specific features and acts described above are disclosed as example aspects.

Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. Additionally, “comprising”, “comprises”, “including”, “includes”, or the like generally means comprising or including, but not limited to.

It will be appreciated that various of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

### LIST OF REFERENCES

[1] A M Okamura, N Smaby, and M R Cutkosky. “An overview of dexterous manipulation”. In: Proceedings 2000 ICRA. Millennium Conference. IEEE International Conference on Robotics and Automation. Symposia Proceedings (Cat. No.00CH37065). Vol. 1. April 2000, 255-262 vol. 1.
[2] Y Tassa, T Erez, and E Todorov. “Synthesis and stabilization of complex behaviors through online trajectory optimization”. In: 2012 IEEE/RSJ International Conference on Intelligent Robots and Systems. October 2012, pp. 4906-4913.
[3] John Schulman, Filip Wolski, Prafulla Dhariwal, Alec Radford, and Oleg Klimov. “Proximal Policy Optimization Algorithms”. In: July 2017. arXiv: 1707.06347 [cs.LG].
[4] OpenAI: Marcin Andrychowicz, Bowen Baker, Maciek Chociej, Rafal J′ozefowicz, Bob McGrew, Jakub Pachocki, Arthur Petron, Matthias Plappert, Glenn Powell, Alex Ray, Jonas Schneider, Szymon Sidor, Josh Tobin, Peter Welinder, Lilian Weng, and Wojciech Zaremba. “Learning dexterous in-hand manipulation”. In: The International Journal of Robotics Research 39.1 (2020), pp. 3-20. DOI: 10.1177/0278364919887447.
[5] Qiang Li, Oliver Kroemer, Zhe Su, Filipe Fernandes Veiga, Mohsen Kaboli, and Helge Joachim Ritter. “A Review of Tactile Information: Perception and Action Through Touch”. In: IEEE Trans. Rob. 36.6 (December 2020), pp. 1619-1634.
[6] P Michelman. “Precision object manipulation with a multifingered robot hand”. In: IEEE Trans. Rob. Autom. 14.1 (February 1998), pp. 105-113.
[7] Susanna Leveroni and Kenneth Salisbury. “Reorienting Objects with a Robot Hand Using Grasp Gaits”. In: Robotics Research. Springer London, 1996, pp. 39-51.
[8] L Han and J C Trinkle. “Dextrous manipulation by rolling and finger gaiting”. In: Proceedings. 1998 IEEE International Conference on Robotics and Automation (Cat. No.98CH36146). Vol. 1. May 1998, 730-735 vol. 1.
[9] R Platt, A H Fagg, and R A Grupen. “Manipulation gaits: sequences of grasp control tasks”. In: IEEE International Conference on Robotics and Automation, 2004. Proceedings. ICRA '04. 2004. Vol. 1. April 2004, 801-806 Vol. 1.
[10] Jean-Philippe Saut, Anis Sahbani, Sahar El-Khoury, and Veronique Perdereau. “Dexterous manipulation planning using probabilistic roadmaps in continuous grasp subspaces”. In: 2007 IEEE/RSJ International Conference on Intelligent Robots and Systems. October 2007, pp. 2907-2912.
[11]T Omata and M A Farooqi. “Regrasps by a multifingered hand based on primitives”. In: Proceedings of IEEE International Conference on Robotics and Automation. Vol. 3. April 1996, 2774-2780 vol. 3.
[12] Yongxiang Fan, Wei Gao, Wenjie Chen, and Masayoshi Tomizuka. “Real-Time Finger Gaits Planning for Dexterous Manipulation ** This project was supported by FANUC Corporation”. In: IFAC-PapersOnLine 50.1 (2017). 20th IFAC World Congress, pp. 12765-12772. ISSN: 2405-8963.
[13] Balakumar Sundaralingam and Tucker Hermans. “Geometric In-Hand Regrasp Planning: Alternating Optimization of Finger Gaits and In-Grasp Manipulation”. In: 2018 IEEE International Conference on Robotics and Automation (ICRA). 2018, pp. 231-238. DOI: 10.1109/ICRA.2018.8460496.
[14] Tingguang Li, Krishnan Srinivasan, Max Qing-Hu Meng, Wenzhen Yuan, and Jeannette Bohg. “Learning Hierarchical Control for Robust In-Hand Manipulation”. In: 2020 IEEE International Conference on Robotics and Automation (ICRA). 2020, pp. 8855-8862. DOI: 10.1109/ICRA40945.2020.9197343.
[15] Filipe Veiga, Riad Akrour, Jan Peters, and. “Hierarchical Tactile-Based Control Decomposition of Dexterous In-Hand Manipulation Tasks”. en. In: Front Robot AI 7 (November 2020), p. 521448.
[16] Fan Shi, Timon Homberger, Joonho Lee, Takahiro Miki, Moju Zhao, Farbod Farshidian, Kei Okada, Masayuki Inaba, and Marco Hutter. “Circus ANYmal: A Quadruped Learning Dexterous Manipulation with Its Limbs”. In: 2021 IEEE International Conference on Robotics and Automation (ICRA). 2021, pp. 2316-2323. DOI: 10.1109/ICRA48506.2021.9561926.
[17] Andrew S. Morgan, Daljeet Nandha, Georgia Chalvatzaki, Carlo D′Eramo, Aaron M. Dollar, and Jan Peters. “Model Predictive Actor-Critic: Accelerating Robot Skill Acquisition with Deep Reinforcement Learning”. In: 2021 IEEE International Conference on Robotics and Automation (ICRA). 2021, pp. 6672-6678. DOI: 10.1109/ICRA48506.2021.9561298.
[18] Aravind Rajeswaran, Vikash Kumar, Abhishek Gupta, Giulia Vezzani, John Schulman, Emanuel Todorov, and Sergey Levine. “Learning Complex Dexterous Manipulation with Deep Reinforcement Learning and Demonstrations”. In: Robotics: Science and Systems XIV, Carnegie Mellon University, Pittsburgh, Pennsylvania, USA, Jun. 26-30, 2018. Ed. by Hadas Kress-Gazit, Siddhartha S. Srinivasa, Tom Howard, and Nikolay Atanasov. 2018. DOI: 10.15607/RSS.2018.XIV.049. URL: http://www.roboticsproceedings.org/rss14/p49.html.
[19] Henry Zhu, Abhishek Gupta, Aravind Rajeswaran, Sergey Levine, and Vikash Kumar. “Dexterous Manipulation with Deep Reinforcement Learning: Efficient, General, and Low-Cost”. In: 2019 International Conference on Robotics and Automation (ICRA). 2019, pp. 3651-3657. DOI: 10.1109/ICRA.2019.8794102.
[20] Ilija Radosavovic, Xiaolong Wang, Lerrel Pinto, and Jitendra Malik. “State-Only Imitation Learning for Dexterous Manipulation”. In: 2021 IEEE/RSJ International Conference on Intelligent Robots and Systems (IROS) (2021), pp. 7865-7871.
[21] A Nagabandi, K Konolige, S Levine, et al. “Deep dynamics models for learning dexterous manipulation”. In: Conference on Robot (2020).
[22] Herke van Hoof, Tucker Hermans, Gerhard Neumann, and Jan Peters. “Learning robot in-hand manipulation with tactile features”. In: 2015 IEEE-RAS 15th International Conference on Humanoid Robots (Humanoids). November 2015, pp. 121-127.
[23] Andrew Melnik, Luca Lach, Matthias Plappert, Timo Korthals, Robert Haschke, and Helge Ritter. “Using Tactile Sensing to Improve the Sample Efficiency and Performance of Deep Deterministic Policy Gradients for Simulated In-Hand Manipulation Tasks”. en. In: Front Robot AI 8 (June 2021), p. 538773.
[24] Tao Chen, Jie Xu, and Pulkit Agrawal. “A Simple Method for Complex In-hand Manipulation”. In: 5th Annual Conference on Robot Learning. 2021.
[25] Sham Machandranath Kakade. “On the sample complexity of reinforcement learning”. en. PhD thesis. Ann Arbor, United States: University of London, University College London (United Kingdom), 2003.
[26] D P de Farias and B Van Roy. “The linear programming approach to approximate dynamic programming”. In: Oper. Res. 51.6 (December 2003), pp. 850-865.
[27] Emanuel Todorov, Tom Erez, and Yuval Tassa. “MuJoCo: A physics engine for model-based control”. In: 2012 IEEE/RSJ International Conference on Intelligent Robots and Systems. October 2012, pp. 5026-5033.
[28] OpenAI, Ilge Akkaya, Marcin Andrychowicz, Maciek Chociej, Mateusz Litwin, Bob McGrew, Arthur Petron, Alex Paino, Matthias Plappert, Glenn Powell, Raphael Ribas, Jonas Schneider, Nikolas Tezak, Jerry Tworek, Peter Welinder, Lilian Weng, Qiming Yuan, Wojciech Zaremba, and Lei Zhang. “Solving Rubik's Cube with a Robot Hand”. In: (October 2019). arXiv: 1910.07113 [cs.LG].
[29] Tao Chen, Jie Xu, and Pulkit Agrawal. “A System for General In-Hand Object Re-Orientation”. November 2021.
[30] Haozhi Qi, Ashish Kumar, Roberto Calandra, Yi Ma, and Jitendra Malik. “In-Hand Object Rotation via Rapid Motor Adaptation”. In: (October 2022). arXiv: 2210.04887 [cs.RO].
[31] Deepak Pathak, Pulkit Agrawal, Alexei A Efros, and Trevor Darrell. “Curiosity-driven Exploration by Self-supervised Prediction”. In: (May 2017). arXiv: 1705.05363 [cs.LG].
[32] Tuomas Haarnoja, Aurick Zhou, Pieter Abbeel, and Sergey Levine. “Soft Actor-Critic: Off-Policy Maxi-mum Entropy Deep Reinforcement Learning with a Stochastic Actor”. In: (January 2018). arXiv: 1801.01290 [cs.LG].
[33] Susan Amin, Maziar Gomrokchi, Harsh Satija, Herke van Hoof, and Doina Precup. “A Survey of Exploration Methods in Reinforcement Learning”. In: arXiv:2109.00157 [cs] (September 2021).
[34] Matthias Plappert, Rein Houthooft, Prafulla Dhariwal, Szymon Sidor, Richard Y Chen, Xi Chen, Tamim As-four, Pieter Abbeel, and Marcin Andrychowicz. “Parameter Space Noise for Exploration”. In: (June 2017).
[35] Ashvin Nair, Bob McGrew, Marcin Andrychowicz, Wojciech Zaremba, and Pieter Abbeel. “Overcoming Exploration in Reinforcement Learning with Demonstrations”. In: (September 2017). arXiv: 1709.10089 [cs.LG].
[36] Adrien Ecoffet, Joost Huizinga, Joel Lehman, Kenneth O Stanley, and Jeff Clune. “Go-Explore: a New Approach for Hard-Exploration Problems”. In: (January 2019).
[37] Adrien Ecoffet, Joost Huizinga, Joel Lehman, Kenneth O Stanley, and Jeff Clune. “First return, then explore”. In: Nature 590.7847 (February 2021), pp. 580-586.
[38] Arash Tavakoli, Vitaly Levdik, Riashat Islam, Christopher M Smith, and Petar Kormushev. “Exploring Restart Distributions”. In: (November 2018).
[39] Yan Duan, Xi Chen, Rein Houthooft, John Schulman, and Pieter Abbeel. “Benchmarking Deep Reinforcement Learning for Continuous Control”. In: (April 2016). arXiv: 1604.06778 [cs.LG].
[40] Optimality and Approximation with Policy Gradient Methods in Markov Decision Processes. PMLR, 2020.
[41] S LaValle. “Rapidly-exploring random trees: a new tool for path planning”. en. In: The annual research report (1998).
[42] Sertac Karaman and Emilio Frazzoli. “Optimal kino-dynamic motion planning using incremental sampling-based methods”. In: 49th IEEE Conference on Decision and Control (CDC). December 2010, pp. 7681-7687.
[43] Dustin J Webb and Jur van den Berg. “Kinodynamic RRT *: Asymptotically optimal motion planning for robots with linear dynamics”. In: 2013 IEEE International Conference on Robotics and Automation. May 2013, pp. 5054-5061.
[44] L E Kavraki, P Svestka, J-C Latombe, and M H Over-mars. “Probabilistic roadmaps for path planning in high-dimensional configuration spaces”. In: IEEE Trans. Rob. Autom. 12.4 (August 1996), pp. 566-580.
[45]L E Kavraki, M N Kolountzakis, and J-C Latombe. “Analysis of probabilistic roadmaps for path planning”. In: IEEE Trans. Rob. Autom. 14.1 (February 1998), pp. 166-171.
[46] Linjun Li, Yinglong Miao, Ahmed H Qureshi, and Michael C Yip. “MPC-MPNet: Model-Predictive Motion Planning Networks for Fast, Near-Optimal Planning Under Kinodynamic Constraints”. In: IEEE Robotics and Automation Letters 6.3 (July 2021), pp. 4496-4503.
[47] Hao-Tien Lewis Chiang, Jasmine Hsu, Marek Fiser, Lydia Tapia, and Aleksandra Faust. “RL-RRT: Kino-dynamic Motion Planning via Learning Reachability Estimators From RL Policies”. In: IEEE Robotics and Automation Letters 4.4 (October 2019), pp. 4298-4305.
[48] Anthony Francis, Aleksandra Faust, Hao-Tien Lewis Chiang, Jasmine Hsu, J Chase Kew, Marek Fiser, and Tsang-Wei Edward Lee. “Long-Range Indoor Navigation With PRM-RL”. In: IEEE Trans. Rob. 36.4 (August 2020), pp. 1115-1134.
[49] Liam Schramm and Abdeslam Boularias. “Learning-guided exploration for efficient sampling-based motion planning in high dimensions”. In: 2022 International Conference on Robotics and Automation (ICRA). Philadelphia, PA, USA: IEEE, May 2022.
[50] Lerrel Pinto, Aditya Mandalika, Brian Hou, and Siddhartha Srinivasa. “Sample-Efficient Learning of Non-prehensile Manipulation Policies via Physics-Based In-formed State Distributions”. In: (October 2018). arXiv: 1810.10654 [cs.RO].
[51] Philippe Morere, Gilad Francis, Tom Blau, and Fabio Ramos. “Reinforcement Learning with Probabilistically Complete Exploration”. In: (January 2020). arXiv: 2001. 06940 [cs.LG].
[52] Tom Jurgenson and Aviv Tamar. “Harnessing Reinforcement Learning for Neural Motion Planning”. In: (June 2019). arXiv: 1906.00214 [cs.RO].
[53] Huy Ha, Jingxi Xu, and Shuran Song. “Learning a Decentralized Multi-arm Motion Planner”. In: (November 2020). arXiv: 2011.02608 [cs.RO].
[54] Arthur Allshire, Mayank Mittal, Varun Lodaya, Viktor Makoviychuk, Denys Makoviichuk, Felix Widmaier, Manuel Wüthrich, Stefan Bauer, Ankur Handa, and Animesh Garg. “Transferring Dexterous Manipulation from GPU Simulation to a Remote Real-World TriFinger”. In: (August 2021). arXiv: 2108.09779 [cs.RO].
[55] Viktor Makoviychuk, Lukasz Wawrzyniak, Yunrong Guo, Michelle Lu, Kier Storey, Miles Macklin, David Hoeller, Nikita Rudin, Arthur Allshire, Ankur Handa, and Gavriel State. “Isaac Gym: High Performance GPU-Based Physics Simulation For Robot Learning”. In: (August 2021). arXiv: 2108.10470 [cs.RO].
[56] Susanna Leveroni and Kenneth Salisbury. “Reorienting Objects with a Robot Hand Using Grasp Gaits”. In: Robotics Research. Springer London, 1996, pp. 39-51.
[57] L Han and J C Trinkle. “Dextrous manipulation by rolling and finger gaiting”. In: Proceedings. 1998 IEEE International Conference on Robotics and Automation (Cat. No.98CH36146). Vol. 1. May 1998, 730-735 vol. 1.
[58]M Yashima, Y Shiina, and H Yamaguchi. “Randomized manipulation planning for a multi-fingered hand by switching contact modes”. In: 2003 IEEE International Conference on Robotics and Automation (Cat. No.03CH37422). Vol. 2. September 2003, 2689-2694 vol. 2.
[59] Jijie Xu, T John Koo, and Zexiang Li. “Finger gaits planning for multifingered manipulation”. In: 2007 IEEE/RSJ International Conference on Intelligent Robots and Systems. October 2007, pp. 2932-2937.
[60] Andrew S Morgan, Daljeet Nandha, Georgia Chalvatzaki, Carlo D′Eramo, Aaron M Dollar, and Jan Peters. “Model Predictive Actor-Critic: Accelerating Robot Skill Acquisition with Deep Reinforcement Learning”. In: (March 2021). arXiv: 2103. 13842 [cs.RO].
[61] Andrew S Morgan, Kaiyu Hang, Bowen Wen, Kostas Bekris, and Aaron M Dollar. “Complex in-hand manipulation via compliance-enabled finger gaiting and multi-modal planning”. In: IEEE Robot. Autom. Lett. 7.2 (April 2022), pp. 4821-4828.
[62] Aditya Bhatt, Adrian Sieler, Steffen Puhlmann, and Oliver Brock. “Surprisingly Robust In-Hand Manipulation: An Empirical Study”. In: (January 2022). arXiv: 2201.11503 [cs.RO].
[63] Gagan Khandate, Maximilian Haas-Heger, and Matei Ciocarlie. “On the Feasibility of Learning Finger-gaiting In-hand Manipulation with Intrinsic Sensing”. In: 2022 International Conference on Robotics and Automation (ICRA). May 2022, pp. 2752-2758.
[64] Tao Chen, Megha Tippur, Siyang Wu, Vikash Kumar, Edward Adelson, and Pulkit Agrawal. “Visual Dexterity: In-hand Dexterous Manipulation from Depth”. In: (November 2022). arXiv: 2211.11744 [cs.RO].
[65] Leon Sievers, Johannes Pitz, and Berthold Bäuml. “Learning Purely Tactile In-Hand Manipulation with a Torque-Controlled Hand”. In: Proc. IEEE International Conference on Robotics and Automation. 2022.
[66] Johannes Pitz, Lennart Rostel, Leon Sievers, and Berthold Bauml. “Dextrous Tactile In-Hand Manipulation Using a Modular Reinforcement Learning Architecture”. In: Proc. IEEE International Conference on Robotics and Automation. 2023.
[67] Jennifer E King, Marco Cognetti, and Siddhartha S Srinivasa. “Rearrangement planning using object-centric and robot-centric action spaces”. In: 2016 IEEE International Conference on Robotics and Automation (ICRA). IEEE. 2016, pp. 3940-3947.
[68] Pedro Piacenza, Keith Behrman, Benedikt Schifferer, Ioannis Kymissis, and Matei Ciocarlie. “A Sensorized Multicurved Robot Finger With Data-Driven Touch Sensing via Overlapping Light Signals”. In: IEEE/ASME Trans. Mechatron. 25.5 (October 2020), pp. 2416-2427.
[69] Lerrel Pinto, Marcin Andrychowicz, Peter Welinder, Wojciech Zaremba, and Pieter Abbeel. “Asymmetric Actor Critic for Image-Based Robot Learning”. In: (October 2017). arXiv: 1710.06542 [cs.RO].
[70] John Schulman, Filip Wolski, Prafulla Dhariwal, Alec Radford, and Oleg Klimov. “Proximal Policy Optimization Algorithms”. In: (July 2017). arXiv: 1707. 06347 [cs.LG].

What is claimed is:

1. A system for generating a model-free reinforcement learning policy for a robotic hand for grasping an object, comprising:
a processor;
a memory; and
a simulator implemented via the processor and the memory, performing:
sampling a plurality of stable grasps relevant to reorienting the grasped object about a desired axis of rotation and using stable grasps as initial states for collecting training trajectories;
learning finger-gaiting and finger-grasping policies for each axis of rotation in the hand coordinate frame based on proprioceptive sensing in the robotic hand,
wherein the finger-gaiting and finger-pivoting policy is implemented on the robotic hand.

2. The system of claim 1, wherein the sampling of a plurality of varied stable grasps comprises initializing the grasped object in a random pose and sampling a plurality of fingertip positions of the robotic hand.

3. The system of claim 2, wherein the sampling is based on a number of fingertip contacts on the grasped object.

4. The system of claim 1, wherein the finger-gaiting and finger-grasping policies for each axis of rotation are combined.

5. The system of claim 1, wherein the proprioceptive sensing provides current positions and controller set-point positions of the robotic hand.

6. The system of claim 1, wherein the robotic hand is a fully-actuated and position-controlled robotic hand.

7. The system of claim 1, wherein a reward function associated with a critic of the simulator is based on the angular velocity of a grasped object along a desired axis of rotation.

8. The system of claim 1, wherein a reward function associated with a critic of the simulator is based on the number of fingertip contacts on a grasped object and the separation between a desired and a current axis of rotation.

9. A method for generating a model-free reinforcement learning policy for a robotic hand for grasping an object, comprising:
sampling a plurality of stable grasps relevant to reorienting the grasped object about a desired axis of rotation and using stable grasps as initial states for collecting training trajectories;
learning finger-gaiting and finger-grasping policies for each axis of rotation in the hand coordinate frame based on proprioceptive sensing in the robotic hand, and
implementing the finger-gaiting and finger-pivoting policy on the robotic hand.

10. The method of claim 9, wherein the sampling of a plurality of varied stable grasps comprises initializing the grasped object in a random pose and sampling a plurality of fingertip positions of the robotic hand.

11. The method of claim 10, wherein the sampling is based on a number of fingertip contacts on the grasped object.

12. The method of claim 9, wherein the finger-gaiting and finger-grasping policies for each axis of rotation are combined.

13. The method of claim 9, wherein the proprioceptive sensing provides current positions and controller set-point positions of the robotic hand.

14. The method of claim 9, further comprising providing a reward function associated with a critic of the simulator is based on the angular velocity of a grasped object along a desired axis of rotation.

15. The method of claim 9, further comprising providing a reward function associated with a critic of the simulator is based on the number of fingertip contacts on a grasped object and the separation between a desired and a current axis of rotation.

16. A robotic hand implementing a model-free reinforcement learning policy for a robotic hand for grasping an object, comprising:
a processor;
a memory storing finger-gaiting and finger-grasping policies built on a simulator by:
a simulator implemented via the processor and the memory, performing:
sampling a plurality of stable grasps relevant to reorienting the grasped object about a desired axis of rotation and using stable grasps as initial states for collecting training trajectories;
learning finger-gaiting and finger-grasping policies for each axis of rotation in the hand coordinate frame based on proprioceptive sensing in the robotic hand, and
a controller implementing the finger-gaiting and finger-pivoting on the robotic hand.

17. The robotic hand of claim 16, wherein the sampling of a plurality of varied stable grasps comprises initializing the grasped object in a random pose and sampling a plurality of fingertip positions of the robotic hand.

18. The robotic hand of claim 17, wherein the sampling is based on a number of fingertip contacts on the grasped object.

19. The robotic hand of claim 16, wherein the finger-gaiting and finger-grasping policies for each axis of rotation are combined.

20. The robotic hand of claim 16, wherein the proprioceptive sensing provides current positions and controller set-point positions of the robotic hand.

21. The robotic hand of claim 16, wherein the robotic hand is a fully-actuated and position-controlled robotic hand.

22. The robotic hand of claim 16, wherein a reward function associated with a critic of the simulator is based on the angular velocity of a grasped object along a desired axis of rotation.

23. The robotic hand of claim 16, wherein a reward function associated with a critic of the simulator is based on the number of fingertip contacts on a grasped object and the separation between a desired and a current axis of rotation.
